(19) United States
(12) Patent Application Publication
(10) Pub. No.: US 2008/0262997 A1
(43) Pub. Date: Oct. 23, 2008

(54) Information Processing Method and Information Processing System

(76) Inventor: Shinji Furusho, Kanagawa (JP)

Correspondence Address: GRIFFIN & SZIPL, PC, SUITE PH-1, 2300 NINTH STREET, SOUTH, ARLINGTON, VA, 22204, US

(21) Appl. No.: 11/568,490

(22) PCT Filed: Apr. 26, 2005
(86) PCT No.: PCT/JP05/07874

§ 371 Date: Jun. 21, 2007

(30) Foreign Application Priority Data
Apr. 28, 2004 (JP) 2004-133320

(51) Int. Cl. G06F 17/30

(52) U.S. Cl. 707/2; 707/E17.002

(57) ABSTRACT

There is provided an information processing method for managing a large amount of data by dividing the data between a plurality of processors. Each processing module holds a local information block containing a pointer arrangement containing information specifying the item value number in the order of records of the table-formatted data and a value list containing item values in the order of the item value numbers corresponding to the item values of the table-formatted data. Each processing module assigns a global order number uniquely determined between a plurality of processing modules to the record of the table-formatted data in the local processing module, compares the value list of the local processing module to the value list of the other processing module, and assigns a global item value number uniquely determined between the processing modules to the item value of the value list of the local processing module.

### TECHNICAL FIELD

The present invention relates to an information processing method and an information processing apparatus which processes a large amount of data, and particularly to an information processing method and an information processing system which adopts the architecture of parallel computers.

### BACKGROUND ART

Conventionally, a data processing to store a large amount of information and to retrieve and aggregate the stored information is performed. The data processing is used in a well-known computer system in which for example, a CPU, a memory, a peripheral equipment interface, an auxiliary storage device such as a hard disk, a display device such as a display and a printer, an input device such as a keyboard and a mouse, and a power unit are connected to one another through a bus, and is particularly provided as software operable on a computer system easily available on the market. In order to perform the data processing such as retrieval and aggregation, various databases to store a large amount of data are known among others. There is a high demand for processing, in the large amount of data, particularly data which can be represented in tabular form.

Whether the large amount of data can be efficiently retrieved or aggregated depends on the form in which the large amount of data is stored. Heretofore, as general storage technologies, the so-called “row-by-row” storage technology and “column-by-column” storage technology are known. In the case of the row-by-row storage technology, a set of item values of gender, age, and occupation constructed for each record number are stored on the disk in order of record numbers and in ascending order of logical addresses. On the other hand, in the case of the column-by-column storage technology, item values are stored on the disk for each item, in order of the record numbers, and in the direction in which the logical address increases.

In the case of the related art, the item values corresponding to all items for all record numbers are directly stored in a two-dimensional data structure (including one dimension of the record numbers and the other dimension of the item values other than the record number). Hereinafter, the data structure as stated above will be referred to as a “data table”. In the case of the related art, when the stored data is retrieved or aggregated, this is performed by accessing the data table.

Besides, in addition to the method in which a value for an item is directly stored as an item value, there is also known a method in which the value is converted to a code, and the code is stored as the item value. Again in this case, it makes no difference in that the code derived by converting the value is stored as the item value in the data table.

In the case where the large amount of data stored by using the data structure of the data table type in the related art is retrieved or aggregated, there is a problem that a longer processing time is required for the retrieval or the aggregation due to an access time for accessing the data table as stated above.

In addition, the data table has essential defects as set forth below.

(1) The size of the data table tends to become enormous, and it is difficult to (physically) divide the data table, for example, for each item or the like. Actually, it is difficult to expand the data table on a high speed storage device, such as a memory, for the accumulation or retrieval.

(2) The data table can not be held in the form in which the respective item values are simultaneously sorted.

(3) Identical values may appear in the data table many times.

Then, in order to greatly improve the speed of retrieval or aggregation of the large amount of data, the present inventor proposes a method of retrieving, aggregating or sorting tabular data and an apparatus to carry out the method by providing a data management mechanism which has a function of a conventional data table and in which the problems of the data structure based on the data table are solved (see, for example, patent document 1).

The proposed method and apparatus for retrieving or aggregating the tabular data introduces a new data management mechanism which can be used in a normal computer system. This data management mechanism includes a value management table and a pointer array to the value management table in principle.

FIG. 1 is an explanatory view of a conventional data management mechanism. In the figure, a value management table 110 and a pointer array 120 to the value management table are shown. The value management table 110 is a table that, for each item of a tabular data, stores item values (see reference numeral 111) corresponding to respective item value numbers and classification numbers (see reference numeral 112) associated with the respective item values in order of the item value numbers which are sequenced (or converted into integer) item values belonging to each item. The pointer array 120 to the value management table is an array in which item value numbers of a certain column (or item) in the tabular data, that is, pointers to the value management table 110 are stored in order of record numbers of the tabular data.

By combining the pointer array 120 to the value management table and the value management table 110, when a certain record number is given, an item value number stored correspondingly to the record number is extracted from the pointer array 120 to the value management table relating to a specified item, and then an item value stored correspondingly to the item value number in the value management table 110 is extracted, so that the item value can be acquired from the record number. Accordingly, similarly to the conventional data table, reference can be made to all data (item values) by using record number (i.e. row) and item (i.e. column) coordinates.

As stated above, the data management mechanism including the value management table created for a certain item in items of tabular data and the pointer array to the value management table will be especially referred to as an information block in the following description.

In the conventional data table, all data are integrally managed by using the coordinates including rows corresponding to records and columns corresponding to items, whereas this information block is characterized in that data is completely separated for each column of a tabular form, that is, for each item. According to this data management mechanism, since a large amount of data is separated for each item, it is possible to load only the data relating to the item necessary for retrieval or aggregation into a high speed storage device such as a memory, and as a result, since an access time to the data is shortened, a processing speed for performing the retrieval or aggregation is enhanced, and even in the case of the data in which the number of items is very large, it can be handled without lowering the performance.

Besides, in the case of this information block, since the item values are stored in the value management table, and the record numbers indicating positions where the values exist are correlated to the pointer array to the value management table, it is not necessary that the item values are arranged in order of recode numbers. Accordingly, the data can be sorted with respect to the item values so that they are suited for the retrieval or aggregation. For this reason, it becomes possible to make a judgment at high speed as to whether the item value coincident with a target value exists in the data. Further, since the item value corresponds to the item value number, even if the item value is long data, a character string or the like, it can be treated as an integer.

Further, according to this data management mechanism, since all item value numbers in the value management table 110 correspond to different item values, the number of times of comparison operation between a specific number and the item value, which is required for extracting the record including the item value having the specific value, is at most the number of kinds of the item values, that is, the number of the item value numbers, the number of times of the comparison operation is remarkably reduced, and the speed of the retrieval or aggregation is enhanced. At that time, a place for storing the result of check as to whether a certain item value is relevant is required, and for example, the classification number 112 can be used as the storage place.

FIG. 2 shows an information block which includes a value management table 210 having an item value array 211 storing item values, a classification number array 212 storing classification numbers, and an existence number array 213 storing existing numbers. In the existence number array 213, a number indicating the number of item values relating to a certain item in all data, in other words, the number of records having a specified item value is stored. When the existence number array 213 as stated above is prepared in the value management table 210, it becomes possible to immediately acquire information required at the time of retrieval, sort, or aggregation, such as “what kind of (and how many) data exists?”, “in which row from the top does this data exist?”, or “what is the x-th data from the top?”, and the speed of the retrieval, sort, or aggregation can be enhanced.

However, also in the data management mechanism as stated above, as the number of records is increased, the value list and the pointer array, especially the pointer array becomes very large, however, the data amount which can be processed is limited by available hardware resources.

The processing of large-scale data is required also in fields other than the information processing of the tabular data as stated above. Nowadays, computers are introduced to various places in society as a whole, and networks including the Internet become widespread, and large-scale data are stored here and there. In order to process the large-scale data, enormous calculation is required, and it is natural to attempt to introduce a parallel processing for that.

A parallel processing architecture is roughly divided into “shared memory type” and “distributed memory type”. The former (“shared memory type”) is a system in which plural processors share one huge memory space. In this system, since the traffic between a processor group and a shared memory becomes a bottle neck, it is not easy to configure a realistic system by using more than one hundred processors. Accordingly, for example, when the square roots of one billion floating-point variables are calculated, an acceleration ratio relative to a single CPU is at most 100 times. Empirically, about 30 times is the upper limit.

In the latter (“distributed memory type”), each of processors has a local memory, and these are combined to configure a system. In this system, it is possible to design a hardware system incorporating several hundred to several tens thousand processors. Accordingly, an acceleration ratio relative to a single CPU at the time when the square roots of one billion floating-point variables are calculated can be made several hundred to several tens thousand times.

[Patent document 1] International Publication WO0/10103

### DISCLOSURE OF THE INVENTION

### Problems that the Invention is to Solve

However, the parallel processing architecture of “distributed memory type” has some problems.

[First Problem: Division of Duties and Management of Huge Array]

The first problem of “distributed memory type” is the problem of division of duties and management of data.

Huge data (since it is generally an array, hereinafter, a description will be made using the array) can not be contained in a local memory of one processor, and is inevitably divided and managed by plural local memories. Unless an efficient and flexible division of duties and management mechanism is introduced, it is apparent that various troubles are caused at the development and execution of a program.

[Second Problem: LOW Efficiency of Inter-Processor Communication]

When each processor of the distributed memory system accesses a huge array, although a quick access can be made to an array element on its own local memory, an access to an array element owned by another processor requires inter-processor communication. As compared with the communication with the local memory, the performance of this inter-processor communication is extremely low, and it is said that at least 100 clocks are taken. Thus, at the time of execution of sorting, reference is made to all areas of the huge array, and the inter-processor communication frequently occurs, and therefore, the performance is extremely lowered.

With respect to this problem, a description will be made more specifically. At the time of 1999, some of personal computers used one to several CPUs and were configured as “shared memory type”. A standard CPU used in this personal computer operates at an internal clock approximately 5 to 6 times faster than that of a memory bus, an automatic parallel execution function and a pipeline processing function are provided within the CPU, and approximately one data can be processed in one clock (memory bus).

Thus, in the multi-processor system of “distributed memory type”, although the number of processors is large, there is a possibility that the speed becomes 100 times lower than that of the single processor (shared memory type).

[Third Problem: Supply of Program]

The third problem of “distributed memory type” is a problem of how to supply a program to many processors.

In a system (MIMD: Multiple Instruction Stream, Multiple Data Stream) in which different programs are loaded to a very large number of processors and the processors as a whole are cooperatively operated, a large load is required for preparing, compiling, and distributing the programs.

On the other hand, in the system (SIMD: Single Instruction Stream, Multiple Data Stream) in which many processors are operated by the same program, the degree of freedom of the program is decreased, and it is conceivable that the program to cause a desired result can not be developed.

Accordingly, in an information processing technique based on the conventional distributed memory, parallel architecture, in order to decrease the inter-processor communication as much as possible, it is desired that large-scale data is not shared among the processors, and the processing of the large-scale data is realized while the large-scale data is held in each processor.

Then, the invention has an object to provide an information processing method for segregating and managing data among a plurality of processors in which parallel computer architecture is adopted and a large amount of data is processed.

Besides, the invention has an object to provide a program for causing a computer to execute the information processing method.

Further, the invention has an object to provide an information processing system for realizing the information processing method.

### Means for Solving the Problems

The invention adopts a distributed memory type, parallel processing architecture in which a value list and a point array are locally held in each processing module as substantial elements of tabular data, and among plural processing modules, indices such as a sequence number (or order) of data rather than the data itself, are globally held. Besides, the invention adopts an algorithm in which processing and communication are integrated so that the data stored in various memories are inputted, outputted and processed by a single instruction.

In order to achieve the objects, according to the invention, an information processing method for building a global information block is provided in an information processing system in which a plurality of processing modules are logically connected to one another in a loop, each of the processing modules includes a memory to store a local information block representing tabular data, and the local information block includes a pointer array which contains information specifying item value numbers in order of records in the tabular data, and a value list which contains item values of the tabular data in order of the item value numbers corresponding to the item values, wherein the method includes

a step of assigning a global sequence number uniquely defined among the plurality of processing modules to the record in the tabular data of each of the processing modules, and

a step of, by each of the processing modules, comparing the value list of each of the processing modules with the value list of another of the processing modules and allocating a global item value number uniquely defined among the plurality of processing modules to the item value in the value list of each of the processing modules. This enables the global sequence number corresponding to the record and the global item value number corresponding to the item value to be uniquely defined among the plurality of processing modules, so that the global information block can be built in which a large amount of global tabular data are segregated and managed by the plurality of processing modules.

In a preferred embodiment, in the step of assigning the global sequence number, the global sequence number is calculated by adding an offset value assigned to each of the processing modules to a number indicating the order of the record of the tabular data of each of the processing modules. This enables the global sequence number to be uniquely defined even if communication is not performed among the processing modules.

In a preferred embodiment, in the step of allocating the global item value number, each of the processing modules sends the value list of each of the processing modules to other processing modules logically connected in the loop, each of the processing modules receives the value lists from the other processing modules, calculates, among the item values in the value list received from the other processing modules, a count of item values which rank previous to the item value in the value list of each of the processing modules, and calculates the global item value number by raising the item value number for the item value in the value list of each of the processing modules by the count. This enables the global item value number to be uniquely defined by the processing in combination with the communication of the value list.

Besides, in order to achieve the objects, according to the invention, in an information processing system in which a plurality of processing modules are logically connected to one another in a loop, each of the processing modules includes a memory to store a local information block representing tabular data, and the local information block includes a pointer array which contains information specifying item value numbers in order of records in the tabular data, and a value list which contains item values of the tabular data in order of the item value numbers corresponding to the item values, global sequence numbers uniquely defined among the plurality of processing modules are assigned to the records in the tubular data of each of the processing modules, and global item value number uniquely defined among the plurality of processing modules are allocated to the item values in the value list of each of the processing modules, there is provided an information processing method for deleting data from a global information block, wherein the method comprises:

a step of identifying records to be deleted, and

a step of lowering global sequence numbers which rank subsequent to the global sequence numbers corresponding to the records to be deleted by the number of the records to be deleted and deleting the information specifying the item value numbers corresponding to the records to be deleted from the pointer array. This makes it possible to delete arbitrary records of the tabular data which are segregated and managed among the plurality of processing modules.

Besides, in order to achieve the objects, according to the invention, in an information processing system in which a plurality of processing modules are logically connected to one another in a loop, each of the processing modules includes a memory to store a local information block representing tabular data, and the local information block includes a pointer array which contains information specifying item value numbers in order of records in the tabular data, and a value list which contains item values of the tabular data in order of the item value numbers corresponding to the item values, global sequence numbers uniquely defined among the plurality of processing modules are assigned to the records in the tubular data of each of the processing modules, and global item value number uniquely defined among the plurality of processing modules are allocated to the item values in the value list of each of the processing modules, there is provided an information processing method for inserting data into a global information block in which the method comprises:

a step of identifying insertion locations of records to be inserted, and

a step of raising global sequence numbers which rank subsequent to the global sequence numbers corresponding to the records to be inserted by the number of the records to be inserted and reserving areas, where the information specifying the item value numbers corresponding to the records to be inserted is stored, at the insertion locations in the pointer array. This makes it possible to add the records at arbitrary locations of the tabular data which are segregated and managed among the plurality of processing modules.

Besides, in order to achieve the objects, according to the invention, in an information processing system in which a plurality of processing modules are logically connected to one another in a loop, each of the processing modules includes a memory to store a local information block representing tabular data, and the local information block includes a pointer array which contains information specifying item value numbers in order of records in the tabular data, and a value list which contains item values of the tabular data in order of the item value numbers corresponding to the item values, global sequence numbers uniquely defined among the plurality of processing modules are assigned to the records in the tubular data of each of the processing modules, and global item value number uniquely defined among the plurality of processing modules are allocated to the item values in the value list of each of the processing modules, there is provided an information processing method for overwrite data of a global information block wherein the method comprises:

a step of identifying a record to be overwritten and setting overwrite data,

a step of creating pairs of item value numbers and item values to represent the overwrite data,

a step of merging the created pairs of the item value numbers and the item values and updating the pointer array and the value list of the local information block including the record to be overwritten, and

a step of, by each of the processing modules, sending the value list of each of the processing modules to other processing modules logically connected in the loop, receiving the value list of the other processing modules, comparing the value list of each of the processing modules with the value list of the another of the processing modules, and allocating new global item value numbers among the plurality of processing modules to the item values in the value list of each of the processing modules. This makes it possible to update data of arbitrary records of the tabular data which are segregated and managed among the plurality of processing modules.

Besides, in order to achieve the objects, according to the invention, in an information processing system in which a plurality of processing modules are logically connected to one another in a loop, each of the processing modules includes a memory to store a local information block representing tabular data, and the local information block includes a pointer array which contains information specifying item value numbers in order of records in the tabular data, and a value list which contains item values of the tabular data in order of the item value numbers corresponding to the item values, global sequence numbers uniquely defined among the plurality of processing modules are assigned to the records in the tubular data of each of the processing modules, and global item value number uniquely defined among the plurality of processing modules are allocated to the item values in the value list of each of the processing modules, there is provided an information processing method for deleting unnecessary data of a global information block wherein the method comprises:

a step of updating the value list so that in the item values stored in the value list of the local information block, item values corresponding to present item value numbers specified by elements of the present pointer array are stored in order of the present item value numbers, and

a step of updating the information specifying the present item value number stored in the present pointer array to specify the item values stored in the updated value list. This enables the unnecessary data of the tabular data which are segregated and managed among the plurality of processing modules to be deleted, and the memory use efficiency and processing efficiency to be raised.

Besides, in order to achieve the objects, according to the invention, in an information processing system in which a plurality of processing modules are logically connected to one another in a loop, each of the processing modules includes a memory to store a local information block representing tabular data, and the local information block includes a pointer array which contains information specifying item value numbers in order of records in the tabular data, and a value list which contains item values of the tabular data in order of the item value numbers corresponding to the item values, global sequence numbers uniquely defined among the plurality of processing modules are assigned to the records in the tubular data of each of the processing modules, and global item value number uniquely defined among the plurality of processing modules are allocated to the item values in the value list of each of the processing modules, there is provided an information processing method for rearranging a global information block wherein the method comprises:

a step of determining the number of new records to be rearranged in each of the processing modules,

a step of assigning new global sequence numbers to the new records to be rearranged based on the number of the new records,

a step of sending, by each of the processing modules, the present global sequence numbers assigned to the present records of each of the processing modules and the item values in the present value list corresponding to the present global sequence numbers to other processing modules logically connected in the loop,

a step of receiving, by each of the processing modules, the present global sequence numbers of the other processing modules and the corresponding item values in the present value list from the other processing modules,

a step of, by each of the processing modules, storing the item values corresponding to the present global sequence numbers coincident with the new global sequence numbers assigned to the new records to be rearranged in each of the processing modules, among the present global sequence numbers received from the another of the processing modules, as a temporary value list into the memory,

a step of, by each of the processing modules, creating a new pointer array which contains information specifying new item value numbers in order of the new records and a new value list which contains the item values in the temporary value list in order of the new item value numbers,

a step of, by each of the processing modules, sending the new value list of each of the processing modules to the other processing modules logically connected in the loop,

a step of, by each of the processing modules, receiving the new value list of the other processing modules, and

a step of, by each of the processing modules, comparing the new value list of each of the processing modules with the new value list of the another of the processing modules and allocating a new global item value number uniquely defined among the plurality of processing modules to the item value of the new value list of each of the processing modules. According to the request of an application, it becomes possible to freely change the allocation of division of the tabular data among the processing modules.

Besides, in order to achieve the objects, according to the invention, there is provided a program to cause a computer of a processing module of an information processing system to execute the information processing method of the invention.

Besides, in order to achieve the objects, according to the invention, there is provided a computer readable recording medium recording the program of the invention.

Further, in order to achieve the objects, according to the invention, there is provided an information processing system including processing modules configured to execute the information processing method of the invention.

### Effects of the Invention

According to the invention, the information processing system can be provided in which a large amount of data can be segregated and managed based on a distributed memory parallel processing architecture.

### BEST MODE FOR CARRYING OUT THE INVENTION

[Hardware Structure]

Hereinafter, embodiments of the invention will be described with reference to accompanying drawings. FIG. 3 is a block diagram showing the outline of an information processing system of an embodiment of the invention. In this embodiment, a processing module is formed of a memory module with processor (hereinafter referred to as “PMM”). As shown in FIG. 3, in this embodiment, in order to logically connect plural processing modules to one another in a loop, plural memory modules with processors PMM 32-0, PMM 32-1, PMM 32-2, are arranged in a ring shape, and adjacent memory modules are connected with each other through a first bus (see, for example, reference numerals 34-0, 34-1) to send data clockwise and through a second bus (see, for example, reference numerals 36-0, 36-1) to send data counterclockwise. In the first bus and the second bus, packet communication between the PMMs is executed. In this embodiment, a transmission path (packet transmission path) in which this packet communication is executed is called the first bus and the second bus.

In this embodiment, the PMMs are connected in a ring shape in which one side is connected by the first bus (first transmission path) to send the packet clockwise, and the other side is connected by the second bus (second transmission path) to send the packet counterclockwise. The structure as stated above is advantageous in that a delay time of packet transmission and the like can be uniformed.

It is noted that the physical connection form among the processing modules is not limited to the form shown in the embodiment, and as long as the processing modules are logically connected to one another in a loop, any form may be adopted. For example, various connection forms, such as bus type and star type, can be adopted.

FIG. 4 is a view showing an example of a structure of the PMM 32. As shown in FIG. 4, each PMM 32-i includes a control circuit 40 to control an access of a memory, execution of an operation and the like in accordance with an instruction common to the PMMs, a bus interface (I/F) 42, and a memory 44.

The memory 44 includes plural banks 0, 1, . . . , n (reference numerals 46-0, . . . , n), and each of them can store a specified array described later.

Besides, the control circuit 40 can give and receive data to and from another external computer or the like. Besides, another computer may access a desired bank of the memory by the bus arbitration.

Further, the memories of the plural memory modules with processors may exist in the same memory space. In this case, the packet communication is realized by memory reference. Alternatively, the processors of the plural memory modules with processors may be physically the same CPU.

[Tabular Data]

The tabular data is data expressed as an array of records including item values corresponding to an item of information. The tabular data becomes, for example, an object of a processing of aggregating item values (measures) of another item for each item value (dimensional value) of a certain item (dimension). Here, the aggregation of the measures is to count the number of measures, to calculate the total sum of the measures, or to calculate the mean value of the measures. Besides, with respect to the dimension number, two dimensions or higher may be adopted. For example, FIG. 5 is logical tabular data of gender, age, and height of children in a certain nursery school. Here, a processing of obtaining the number of persons for each gender, or a processing of obtaining the total value of heights for each gender/age is an aggregation processing as an example of an information processing realized by applying the invention.

The invention provides a building technique of data structure for realizing a high speed and parallel information processing of tabular data as stated above, an update technique of data, and a rearrangement technique of data.

[Conventional Storage Structure of Data]

The tabular data shown in FIG. 5 is stored as a data structure shown in FIG. 6 in a single computer by using the data management mechanism proposed in the International Publication WO00/10103.

As shown in FIG. 5, in an array 601 to cause sequence numbers of respective records of the tabular data to correspond to sequence numbers of inner data (hereinafter, this array is referred to as “OrdSet”), the sequence numbers of the inner data are arranged as values for the respective records of the tabular form. In this example, since all the tabular data are expressed as the inner data, the record numbers of the tabular data and the sequence numbers of the inner data are coincident with each other.

For example, with respect to the gender, it is understood that the sequence number of the inner data corresponding to the record 0 of the tabular data is “0” from the array OrdSet 601. The value of the actual gender relating to the record where the sequence number is “0”, that is, “male” or “female” can be acquired by referring to a pointer array 602 (hereinafter, the pointer array is abbreviated to “VNo”) to a value list 603 (hereinafter, the value list is abbreviated to “VL”) in which the actual values are sorted in accordance with a specified order. The pointer array 602 stores pointers to indicate elements in the actual value list 603 in accordance with the order of the sequence numbers stored in the array OrdSet 601. Thus, the item value of the gender corresponding to the record “0” of the tabular data can be acquired by (1) extracting the sequence number “0” corresponding to the record “0” from the array OrdSet 601, (2) extracting the element “1” corresponding to the sequence number “0” from the pointer array 602 to the value list, and (3) extracting, from the value list 603, the element “female” indicated by the element “1” extracted from the pointer array 602 to the value list.

Also with respect to another record, and also with respect to the age and height, the item value can be acquired similarly.

As stated above, the tabular data is represented by the combination of the value list VL and the pointer array VNo to the value list, and this combination will be especially called “information block”. FIG. 6 shows information blocks relating to the gender, age and height as information blocks 608, 609 and 610, respectively.

When a single computer has a single memory (although it may be physically formed of a plurality of memories, the memories are regarded as the single memory in the meaning that they are arranged and are accessed in a single address space) it is sufficient to store only the array OrdSet of the ordered set, and the value list VL and the pointer array VNo constituting each information block in the memory. However, since the memory capacity is also increased in proportion to the magnitude thereof, in order to hold a large number of records, it is desired that these can be distributed and arranged. Besides, also from the viewpoint of parallelization of processing, it is desired that the distributed and arranged information can be segregated and managed.

Then, in this embodiment, the plural PMMs segregate and manage the data of the record without overlap, and realize high speed accumulation by packet communication among the PMMs.

[Data Storage Structure of this Embodiment]

FIG. 7 is an explanatory view of a data storage structure according to the embodiment. In the figure, the tabular data shown in FIG. 5 and FIG. 6 is, as an example, distributed and arranged in four processing modules of PMM-0, PMM-1, PMM-2 and PMM-3, and is segregated and grasped. For convenience of explanation, although the number of processing modules is four, the invention is not limited to the number of the processing modules.

In this embodiment, a global record is uniquely assigned to each record so that records segregated and grasped by each PMM can be uniquely ordered in all records grasped by the four PMMs of PMM-0 to PMM-3. In FIG. 7, the global record number is expressed by “GOrd”. The global record number GOrd indicates a sequence number among all records where each element of the array OrdSet in each PMM is located. Here, since the array OrdSet is determined so as to be a map from the whole data to the data in each PMM while keeping a sequence, the GOrd can be placed in ascending order. Besides, in each PMM, the size of the GOrd array (=global ordered array) is coincident with the size of the OrdSet array (ordered array).

Further, in this embodiment, there is provided a global item value number to indicate at which position is each of the item values segregated and grasped by each PMM, that is, each value in the value list VL is located within the item values managed by all the PMMs. In FIG. 7, the global item value number is denoted by “GVNo”. Since the value list VL is arranged in order of value (for example, in ascending order or descending order), the global item value number GVNo is also set in ascending order (or descending order). The size of the array GVNo is coincident with the size of the array VL. By recognizing that the item value individually grasped in each processing module is located at which number in the whole, the accumulation results in the respective processing modules can be integrated into one as a whole.

Incidentally, in FIG. 7, a value OFFSET assigned to each PMM is an offset value for indicating at which position is a first record grasped by the PMM located among the whole records shown in FIG. 6. As described above, since the array OrdSet of each PMM is determined so as to be the map keeping the sequence from the whole data to the data in each PMM, the value of the sum of this offset value OFFSET and the value of the element of the array OrdSet in the PMM is coincident with the global record number GOrd. Preferably, this offset value is notified to each PMM, and each PMM can determine the global record number based on this offset value OFFSET.

Although the global record number GOrd of each PMM and the global item value number GVNo are previously calculated in the outside of each PMM and can be set in each PMM, they can also be set by each PMM itself by an after-mentioned compile processing.

[With Respect to Global Set Array Gord and Global Item Value Number Array GNo]

Next, the meaning of the array GOrd and the array GVNo introduced in this embodiment will be described. The global ordered array GOrd indicates the position (order) of each record of tabular data grasped by each PMM in the global tabular data in which local tabular data grasped by the respective PMMs are collected. That is, in this embodiment, the position information of the record is divided into the global component and the local component by the global ordered array GOrd and the ordered array OrdSet, and thus, the global tabular data can be treated, and each PMM can singly execute a processing.

In the following description of the embodiment, although the PMM is constructed so as to hold the information block for each item, even in the case where the PMM holds the tabular data as it is, the GOrd functions similarly.

For example, in the following embodiment, in the state where the after-mentioned compiling is ended, when the item values of each item are extracted in order of value of the global order array GOrd, the view of the whole tabular data can be created.

[Outline of Compile Processing]

The compile processing is the processing for setting the global record number GOrd used for management of data in each processing module and the Global item value number GVNo. The global record number GOrd can be easily set by using the offset value OFFSET. On the other hand, the global item value number GVNo is the number ordered commonly among all processing modules based on the value list which is held individually by each processing module. Each processing module can set the global item value number GVNo by using this sequence number allocation processing. Then, the sequence number allocation processing will be described.

[Sequence Number Allocation Processing]

Like the information processing system according to this embodiment, in an information processing system in which plural processing modules each including a memory storing a list of ordered values are logically connected to one another in a loop, an information processing method of allocating sequence numbers common to the plural processing modules to values ordered individually in each processing module, that is, a sequence number allocation method is required.

The sequence number allocation processing is used also in the case where, for example, in a compile processing, a global item value number is set. This sequence number allocation processing is characterized in that only one number is allocated to the identical value. Accordingly, this type of sequence number allocation processing will be especially called an identical value erasing type sequence number allocation processing.

FIG. 8 is a flowchart of the sequence number allocation method according to the embodiment. As shown in the figure, each processing module stores an initial value of a sequence number of each value in a value list in the processing module itself into the memory (step 801).

Next, each processing module sends the value list stored in the memory of each processing module to the processing module logically connected to a next stage (step 802). Further, each processing module counts, with respect to each value in the value list in each processing module, the number of values which rank previous to the each value in the value list received from the processing module logically connected to a former stage, and raises the sequence number of each value in the value list in each processing module by the counted number, so that the sequence number of each value in the value list in each processing module is updated, and the updated sequence number is stored in the memory (step 803).

Next, each processing module sends a further value list in which a value coincident with a value in the value list of each processing module is removed from values in the received value list, to the processing module logically connected to the next stage (step 804). Each processing module counts, with respect to each value in the value list of each processing module, the number of values which rank previous to the each value in the further value list received from the processing module logically connected to the former stage, and raises the sequence number of each value in the value list of each processing module by the counted number, so that the sequence number of each value in the value list of each processing module is updated, and the updated sequence number is stored in the memory (step 805).

Subsequently, each processing module repeatedly executes step 2204 and step 2205 until the value list sent to the processing module logically connected to the next stage at transmission step 802 is received by the processing module logically connected to the former stage through the other processing modules logically connected in a loop (step 806).

According to this sequence number assignment method, each processing module receives the value lists held by other processing modules without duplication, and can allocate the global sequence numbers to the values held by each processing module. As described above, in the case where each processing module holds the list of ordered values previously, the global sequence numbers can be allocated very efficiently. This is because, in the case where the value list is previously ordered, the order has only to be compared in one direction of the ascending order (or descending order). Of course, even in the case where the value list held by each processing module is not ordered, the same result can be obtained. In that case, for example, each processing module sequentially compares the values in the value list received from other processing modules with values in the value list held by each processing module with respect to all combinations, counts the number of values which rank previous to each value, that is, are ordered at an higher rank, and has only to update the sequence number of each value.

In the sequence number allocation method of this embodiment, each processing module is not required to store the value lists received from other processing modules, and the sequence number common to all processing modules can be allocated only by ordering the value list held by each processing module.

Besides, since this sequence number assignment method is not influenced by the order of reception of the value lists from other processing modules, it does not depend on the physical connection form among the processing modules at all. Accordingly, by multiplying the transmission path and the sequence number update circuit, a further speedup can be realized.

FIGS. 9A to 9D and FIGS. 10A to 10D are explanatory views of a first sequence number allocation processing. In FIGS. 9A to 9D, value lists sent by respective PMMs to PMMs connected to the next stage are shown for each step. FIGS. 10A to 10D show value lists received at each step by PMMs from PMMs connected to the former stage. In this example, as an initial state, a PMM-0 holds a value list of [1, 3, 5, 6], a PMM-1 holds a value list of [0, 2, 3, 7], a PMM-2 holds a value list of [2, 4, 6, 7], and a PMM-3 holds a value list of [0, 1, 3, 5].

At the end time point of step 3, each PMM can receive the value lists from all the other processing modules. At this time point, the value list held by each processing module and the received value lists are combined, so that the sequence of all values can be determined. Further, it is understood that at the end time point of step 4, all values can be received without duplication.

In this first sequence number allocation processing, the processing modules are logically connected to one another in the loop as shown in FIGS. 9A to 9D, and each processing module holds a list without duplicate values in each processing module. Then, each processing module sends the list in each processing module to a logically downstream processing module, and receives just one list from a logically upstream processing module. Each processing module removes the value identical to the value included in the list held in each processing module from the values in the list received from the upstream module, and sends the list, from which the identical value is removed, to the downstream processing module.

According to the first sequence number allocation processing, when the total number of the processing modules is N, each processing module can receive lists held by the other processing modules without duplication until the end of (N−1) transmission cycles. Besides, each processing module can receive lists held by all the modules without duplication until the end of N transmission cycles. Especially, when a value list held in each processing module is arranged in ascending order of value or descending order of value, the processing of deleting a duplicate value can be executed more efficiently.

The first sequence number allocation processing is very excellent in that all processing modules can be realized by the same structure. However, in this first sequence number allocation processing, there is a case where one value is deleted many times, and/or transfer is performed many times. Specifically, in the case where the same value occurs in many processing modules, the value is erased each time it passes through the processing module having the value. Besides, when the number of processing modules is made N, (N−1) transfers are performed until data from the farthest processing module reaches to a certain processing module.

The number of times of this transfer can be further reduced by introducing an additional mechanism called a tournament system described later.

FIG. 11 is an explanatory view of a first example of a tournament device 1100 to allocate a sequence number according to an embodiment of the invention. In the figure, similarly to the example described in FIGS. 9A to 9D and FIGS. 10A to 10D, a PMM-0 holds a value list of [1,3,5,6], a PMM-1 holds a value list of [0,2,3,7], a PM-2 holds a value list of [2,4,6,7], and a PMM-3 holds a value list of [0,1,3,5] as an initial state.

At a first step, the PMM-0 sends the value list [1,3,5,6] in the processing module itself to a combination device 1, the PMM-1 sends the value list [0,2,3,7] in the processing module itself to the combination device 1, the PMM-2 sends the value list [2,4,6,7] in the processing module itself to a combination device 2, and the PMM-3 sends the value list [0,1,3,5] in the processing module itself to the combination device 2.

At a next step, the combination device 1 deletes a duplicate value from the value lists received from the PMM-0 and the PMM-1 to create a value list [0,1,2,3,5,6,7], and sends it to a combination device 3. Similarly, the combination device 2 deletes a duplicate value from the value lists received from the PMM-2 and the PMM-3 to create a value list [0,1,2,3,4,5,6,7] and sends it to the combination device 3. At a final step, the combination device 3 deletes the duplicate value from the value lists received from the combination device 1 and the combination device 2 to create a value list [0,1,2,3,4,5,6,7] and broadcasts this value list to the respective processing modules of the PMM-1 to PMM-4.

In this example, erasing the duplicate value of the value lists is performed in the combination device rather than the processing module. When the value list is arranged in ascending order or descending order, the combination device is sufficient to combine the lists in the ascending order or descending order, so that the combination device can be realized by a small number of buffer memories if a flow control is possible.

In this example, although the combination device and the processing module are completely separated from each other, a partial combination processing may be performed by the processing module. FIG. 12 is an explanatory view of a second example of a tournament device 1200 to allocate a sequence number according to an embodiment of the invention as stated above. In the figure, similarly to FIG. 11, as an initial state, a PMM-0 holds a value list [1,3,5,6], a PMM-1 holds a value list [0,2,3,7], a PMM-2 holds value list [2,4,6,7], and a PMM-3 holds a value list [0,1,3,5].

At a first step, the PMM-0 sends the value list [1,3,5,6] in the processing module itself to the PMM-1, and the PMM-2 sends the value list [2,4,6,7] in the processing module itself to the PMM-3.

At a next step, the PMM-1 combines the value list received from the PMM-0 and the value list [0,2,3,7] in the processing module itself, deletes a duplicate value to create a value list [0,1,2,3,5,6,7], and sends it to a combination device 3. Similarly, the PMM-3 combines the value list received from the and the value list [0,1,3,5] of the processing module itself, deletes a duplicate value to create a value list [0,1,2,3,4,5,6,7], and sends it to the combination device 3.

At a final step, the integrating device 3 deletes a duplicate value from the value lists received from the combination device 1 and the combination device 2 to create a value list [0,1,2,3,4,5,6,7], and broadcasts this value list to the respective processing modules of the PMM-1 to PMM-4.

In the example of FIG. 12, the processing module PMM-2 (and/or the PMM-0) is not used for the combination processing. Then, the role of the combination device 3 to combine the output from the PMM-1 and the output from the PMM-3 may be substituted by the PMM-2 or PMM-0. FIG. 13 is an explanatory view of a third example of a tournament device 1300 to allocate a sequence number according to an embodiment of the invention as stated above. According to this example, since the number of combination devices becomes the number of processing modules −1, in general, even in the case where a very large number of processing modules exist, unlike the example shown in FIG. 11 or FIG. 12, the sequence number allocation processing of the tournament system can be realized without providing an independent combination device separately from the processing modules.

In the examples described with reference to FIG. 11 to FIG. 13, the memory space may be a single memory space, and plural CPUs may exist. The communication path between the processing modules and the combination devices is a logical communication path, and even in the case where the communication is physically realized by memory reference, the sequence number allocation processing of the tournament system can be realized.

[Details of Compile Processing]

FIG. 14 is an explanatory view of an information block on a single computer (or a processing module) to represent tabular data. In the figure, OrdSet denotes an ordered array to indicate the order of records of the tabular data as already described, VNo denotes a pointer array in which information (or item value numbers themselves) to specify item value numbers in the order of the records is stored, and VL denotes a value list in which item values are stored in the order of the item value numbers. The compile processing is the processing of configuring a data structure in which the tabular data as stated above is segregated and managed by plural processing modules.

FIG. 15 is an explanatory view of a data structure in which the tabular data of FIG. 14 is segregated and managed by four processing modules PMM-0, PMM-1, PMM-2 and PMM-3. In the figure, Gord denotes a global sequence number to indicate at which position is a record managed in each processing module located within the whole records, and GVNo denotes a global item value number to indicate at which position is a value in a value list managed in each processing module located within the whole values.

The compile processing is the processing of converting the data structure shown in FIG. 14 into the data structure shown in FIG. 15. FIG. 16 is a flowchart of the compile processing according to an embodiment of the invention. In the compile processing of this example, at step 1601, an offset value assigned to each processing module is added to numbers indicating the order of records of tabular data of each processing module, and global sequence numbers, that is, values of elements of a global ordered array are calculated. The offset value is determined based on the number of records assigned to each processing module. In the example of FIG. 15, the offset value is 0, 3, 5 and 8 in order of from PMM-0 to PMM-3.

Next, at steps 1602 to 1607, each processing module uses the sequence number allocation processing described with reference to FIG. 8, and gives a global item value number to an item value in each processing module. The global item value number is such that each processing module compares the value list of the processing module itself and the value list of another processing module, and the global item value number is uniquely defined among plural processing modules with respect to the item value in the value list of the processing module itself.

At step 1602, each processing module sends the value list of each processing module to other processing module logically connected in a loop, and next, at step 1603, receives, from another processing module, the value list of the another processing module. At step 1604, each processing module deletes a duplicate value in the received value lists. At step 1605, each processing module counts the number of values which rank previous to the item value in the value list of each processing module among the item values in the value list received from the another processing module, and raises the item value number of the item value in the value list of each processing module by the number. At step 1606, each processing module sends the value list, which has been received from the processing module and from which the duplicate value has been deleted, to a further another processing module connected logically subsequent to each processing module. At step 1607, each processing module repeats the processing of from step 1602 to step 1606 on the value lists sent from other processing modules, and the allocation of the global item value numbers is ended.

[Data Update Processing]

With respect to the tabular data managed in the data structure as shown in FIG. 15, various processes are performed. In addition to the processing such as retrieval, sorting, or aggregation, the basic operation such as deletion of data, insertion of data, or overwriting of data is performed on the tabular data. Then, next, a data update processing on the data structure of the invention in which data is divided and managed by the respective processing modules will be described.

[Record Deletion Processing]

For example, with respect to a case where in the tabular data shown in FIG. 15, two data (two rows) of the record of GOrd=2 held in the PMM-0 and the record of GOrd=3 held in the PMM-1 are deleted, the record delete processing according to an embodiment of the invention will be described.

The record delete processing includes a step of identifying a record to be deleted, and a step of lowering a global sequence number which ranks subsequent to a global sequence number corresponding to the record to be deleted and deleting information specifying an item value number corresponding to the record to be deleted from a pointer array.

In FIG. 17, letters corresponding to the two records to be deleted are indicated by bold italic types. When a record is deleted, a global sequence number GOrd allocated to records, a pointer array VNo in which item value numbers are stored in order of records, and a local sequence number OrdSet uniquely allocated to the records in each processing module must be updated. However, at this stage, the value list VL is not updated. This is because, for the update of the value list, it is necessary to confirm that there is no record referring to the item value stored in the value list, that is, that there is no VNo specifying the item value. Since the value list VL is not updated, it is also unnecessary to update the global item value number GNo.

The update of GOrd is performed by lowering the global sequence number which ranks subsequent to the global sequence number corresponding to the record to be deleted by the number of records to be deleted. In this example, first, GOrd=2 of PMM-0 and GOrd=3 of PMM-1 are deleted, and next, in the PMM in which the global sequence number is deleted, the global sequence number stored behind the deleted global sequence number is moved forward. In the PMM-0, since GOrd=2 is the last global sequence number, the movement of the global sequence number is not performed, whereas in the PMM-1, since GOrd=4 exists behind the deleted GOrd=3, this GOrd=4 is moved forward by one. Further, with respect to a remaining global sequence number, in the case where a deleted global sequence number exists in front of the global sequence number, the value of the global sequence number is decreased by the number of the deleted ones (in the case of descending order). FIG. 18 is an explanatory view of the record delete processing according to an embodiment of the invention, and the figure shows a state where the global sequence number GOrd is updated.

In the update of OrdSet, the OrdSet existing at the same place as the deleted GOrd is deleted, and further, in the PMM in which the OrdSet is deleted, the OrdSet stored behind the deleted OrdSet is moved forward by the number of the deleted ones, and the value is decreased by the number of the deleted ones. FIG. 18 shows also a state where the OrdSet is updated.

Finally, with respect to the pointer array VNo, and with respect to all items of “gender”, “age”, “height” and “weight”, the VNo specified by the OrdSet corresponding to the record to be deleted is deleted, and in the PMM in which the VNo is deleted, VNo stored behind the deleted VNo is moved forward by the number of the deleted ones. FIG. 18 shows also a state where the VNo is updated.

By the above processing, the tabular data after the record deletion as shown in FIG. 19 is obtained.

[Record Insertion Processing]

For example, in the tabular data shown in FIG. 19, with respect to a case where two records are inserted in PMM-1, a record insertion processing according to an embodiment of the invention will be described. According to this embodiment, the record insertion processing is the processing of reserving a storage area of the record to be inserted, and the item value of the record to be inserted is made a specified value, so that the speed of the processing is enhanced. For example, as a tentative item value of each item of the record to be inserted, a minimum item value held in the PMM in which the record is to be inserted is used.

The record insertion processing includes a step of identifying insertion locations of records to be inserted, and a step of raising global sequence numbers which rank subsequent to the global sequence numbers corresponding to the records to be inserted by the number of the inserted ones and reserving an area, where information specifying the item value numbers corresponding to the records to be inserted is stored, at the insertion locations in the pointer array.

Although the presently existing record in the PMM-1 of the tabular data of FIG. 19 is only one record of GOrd=2, since this tabular data is the tabular data created by deleting the record from the tabular data of FIG. 17, the item value of the deleted record, that is, “gender”=female, “age”=16, “height”=172 and “weight”=48 also exist in the PMM-1. At this time, the minimum item value held in the PMM-1 is “gender”=male, “age”=16, “height”=172 and “weight”=48. Accordingly, the tentative item values of the record to be inserted in the PMM-1 are “gender”=male, “age”=16, “height”=172 and “weight”=48. FIG. 20 is an explanatory view of the record insertion processing according to the embodiment of the invention. In the figure, data to be inserted is indicated by bold italic types. An example of a procedure of the record insertion processing is as follows.

(Procedure 1) GOrd, OrdSet and VNo are created at positions where records are to be inserted.

(Procedure 2) Values corresponding to the created positions are set in the created GOrd. In this example, since the records are inserted to the first and second positions in the PMM-1, the values in the GOrd corresponding to the positions, 2 and 3 are set. Besides, the GOrd of the record which ranks subsequent to the records inserted in the PMM-1 is incremented by the number of the inserted records.

(Procedure 3) A value corresponding to the position where the OrdSet is created in the PMM is set in the created OrdSet. In the example, since the records are inserted to the first and second positions in the PMM-1, values in the OrdSet corresponding to the positions, 0 and 1 are set. Besides, the OrdSet of the record which ranks subsequent to the records inserted in the PMM-1 is incremented by the number of the inserted records.

(Procedure 4) In the created VNo, 0 is set. Since the item value of the created record is the minimum item value, VNo is fixed to 0.

By the above processing, tabular data after the record insertion as shown in FIG. 21 is obtained. Besides, the value of the inserted record can be set to a desired value by an after-mentioned data overwriting processing.

It is noted that, in the above example, although the smallest value 0 is set in VNo, for example, it may remain blank.

Besides, in the above example, since the record of at least one row exists in the PMM-1, as the item value of the record to be inserted, the smallest item value in the existing data is used, however, in the case where data does not exist in the PMM in which the record is to be inserted, for example, the smallest item value in which the global item number becomes GVNo=0 is used and the data can be created. Also in this case, VNo is 0, and the value in the VL is the smallest value among item values held in all PMMs.

[Data Overwriting Processing]

Since the data inserted by the record insertion processing is set to the specified value, it becomes necessary to rewrite the set specified value by actually desired data. Then, next, the data overwriting processing according to an embodiment of the invention to perform rewriting of data as stated above will be described. FIG. 22 is an explanatory view of an example in which a part of the tabular data shown in FIG. 15, specifically, the height of the second record and the third record of the PMM-0 and the height of the first record of the PMM-1 are overwritten. FIG. 23 is a flowchart of the data overwriting processing according to the embodiment of the invention.

In the data overwriting processing, at step 2301, a data array to be overwritten is compiled. Specifically, the records to be overwritten are identified, the overwrite data is set, and pairs of item value numbers and item values to represent the overwrite data are created. FIG. 24 is an explanatory view of a processing of compiling the data to be overwritten in each PMM. In the figure, the processing in the PMM-0 is shown.

Next, at step 2302, the value list VL is merged. The created pairs of the item value numbers and the item values are merged, so that a value list of a local information block including the records to be overwritten is created. FIG. 25A to FIG. 25D are explanatory views of a processing of merging the overwrite data and the original data. In the merge processing, first, P1 to indicate the position of VL of the overwrite data, P2 to indicate the position of VL of the original data, and a pointer P3 to indicate the position of a new value list VL created by the merging are initialized to 0.

In procedure 1 of the merge processing of FIG. 25A, P1 and P2 are compared, and since P2 is small, the value 0 of P3 is stored at the position 0 of Conv. specified by P2. Next, the value 159 of VL specified by P2 is stored in the new VL. Subsequently, P2 and P3 are incremented. Here, the array Conv. denotes a position where the corresponding value is stored in the new VL. For example, since the value of Conv. corresponding to the head value 159 of VL of the original data is 0, the item value 159 is the head value of the new VL.

In procedure 2 of the merge processing of FIG. 25B, P1 and P2 are compared, and since P1 is small, the value 1 of P3 is stored at the position 0 of Conv. specified by P1. Next, the value 160 of VL specified by P1 is stored in the new VL. Subsequently, P1 and P3 are incremented.

In procedure 3 of the merge processing of FIG. 25C, P1 and P2 are compared, and since P2 is small, the value 2 of P3 is stored at the position 1 of Conv. specified by P2. Next, the value 168 of VL specified by P2 is stored in the new VL. Subsequently, P2 and P3 are incremented.

In the following, similarly, the procedure of the merge processing of the VL is continued, and the merge result as shown in FIG. 25D is obtained.

In the description of the merge processing of the VL, although the new VL is simultaneously created, the new VL can be created from the VL of the overwrite data and the corresponding Conv. and the VL of the original data and the corresponding Conv.

Next, at step 2303, the pointer array VNo of the local information block including the records to be overwritten is updated. FIGS. 26A to 26C are explanatory views of a processing of updating the pointer array.

First, as shown in FIG. 26A, the VNo of the overwrite data and the VNo of the original data are converted to VNo corresponding to the new VL by using the respective corresponding Conv. For example, since 1 is stored at the position corresponding to the record 0 of the array VNo of the overwrite data, the item value number of the present VL of the record 0 is 1. It is understood that the item value number of the present VL corresponds to the item value number 4 of the new VL when reference is made to the array Conv. Then, the value of the element corresponding to the record 0 of VNo is converted from 1 to 4. In the following, similarly, with respect to all records of the overwrite data and all records of the original data, the values of VNo are converted.

Next, as shown in FIG. 26B, the VL is replaced by the new VL, and the VNo of the overwrite data is transferred to the position in VNo of the original data where overwriting is to be performed. By this, new VNo and VL as shown in FIG. 26C are completed.

Also with respect to the PMM-2, when the merge processing is performed similarly, the tabular data of FIG. 22 is converted into tabular data as shown in FIG. 27. In the overwriting processing of this example, since the data of “height” is rewritten, the global item value number GVNo concerning “height” must be reconfigured.

Then, finally, at step 2304, the global item value number GVNo is reconfigured. Specifically, each processing module sends a value list of the processing module itself to another processing module logically connected in a loop, receives a value list of another processing module from the another processing module, compares the value list of the processing module itself with the value list of the another processing module, and allocates a new global item value number among plural processing modules to the item value in the value list of the processing module itself. This corresponds to the foregoing sequence number allocation processing. By this, the data of the global information block can be overwritten. FIG. 28 is an explanatory view of the tabular data completed by the data overwriting processing of this example.

[Sweep Processing]

In the record deletion processing and the data overwriting processing, since the item value corresponding to the deleted record and the item value corresponding to the original data prior to the overwriting remain as they are, there is a case where data not actually used is included in the VL and GVNo. It is desired that the data not used as stated above can be erased. Then, according to the invention, the sweep processing of removing unnecessary data is provided. FIGS. 29A and 29B are explanatory views of an embodiment of the invention. As shown in FIGS. 29A and 29B, according to this sweep processing, the VL and GNo are condensed, and the VNo is updated.

In this sweep processing, the value list is updated so that among the item values stored in the value list VL of the local information block, item values corresponding to the present item value numbers specified by the elements of the present pointer array VNo are stored in order of the present item value numbers, and next, the present item value number stored in the present pointer array is updated so that the item value stored in the updated value list is specified. By updating the value list, the global item value number GVNo not used is also erased. By this, unnecessary data of the global information block is removed.

FIG. 30 is a flowchart of the sweep processing of the embodiment of the invention. FIGS. 31A to 31H are explanatory views of proceeding states of the sweep processing based on the example shown in FIGS. 29A and 29B.

Step 3001: First, a flag array Flag is created. The Flag is an integer array having the same size as VL (and GVNo), and its elements are initialized to 0.

Step 3002: Elements (indicated by italic types in FIG. 31B) of the Flag array at addresses indicated by VNo are changed from 0 to 1. The value in the flag is 0 or 1.

Step 3003: Values (indicated by italic types in FIG. 31C) in the VL corresponding to the positions where the Flag is 1 are inserted in a new VL from the head in order.

Step 3004: Values (indicated by italic types in FIG. 31D) in the GVNo corresponding to the positions where the Flag is 1 are inserted in a new GVNo from the head in order.

Step 3005: The Flag is accumulated and is moved backward by one stage. The accumulated Flag is denoted by Flag′. Flag′ of the accumulated Flag is shown in FIG. 31E.

Step 3006: Finally, VNo is converted by referring to Flag′. FIGS. 31F to 31H show the conversion processing of VNo. For example, with respect to the head element VNo[0]=2 in the present VNo, when reference is made to the third element Flag′[2] (indicated by bold italic type) in the array Flag′, since the value is 1, 1 is set to the VNo[0] (indicated as 2→1 in FIG. 31F).

By the above processing, the data before the sweep, as shown in FIG. 29A, is converted into the data after the sweep of FIG. 29B.

It is noted that, in this sweep processing, although the values in the GVNo used hold the ascending order (or descending order), there is a possibility that the GVNo may have discrete values. As long as the GVNo keeps the ascending order (or descending order), the global information block according to the invention is effective, and the processing such as retrieval, sorting, or aggregation can be performed even if the values are discrete. Of course, as the need arises, the GVNo can be reconfigured so that the GVNo has continuous values. The reconfiguration of the GVNo can be realized using the foregoing sequence number allocation processing.

This sweep processing may be automatically performed, or may be performed according to a request from a user.

[Data Rearrangement]

The data rearrangement is to change the data allocation indicating that when tabular data is segregated and managed by plural processing modules, which record is held by which processing module. When the processing result of retrieval, sort or accumulation of tabular data is outputted to a disk device or the like, this data rearrangement is requested when all of or part of the tabular data is made independent and is managed as the other tabular data. For example, when tabular data is outputted to a sequential device, it is desirable that this tabular data is arranged sequentially also on the information processing system.

In the data rearrangement processing according to the embodiment of the invention, numbers in ascending order among all processing modules are allocated to the global sequence number GOrd, and numbers in ascending order starting from 0 in each processing module are allocated to OrdSet.

FIG. 32 is a flowchart of the data rearrangement processing according to the embodiment of the invention. The information processing system in which the data rearrangement processing is executed includes plural processing modules logically connected to one another in a loop, and each of the processing modules includes a memory to store a local information block representing tabular data. The local information block includes a pointer array which contains information specifying item value numbers in order of records of the tabular data, and a value list which contains item values in order of the item value numbers corresponding to the item values of the tabular data. The global sequence number GOrd uniquely defined among the plural processing modules is assigned to the record in the tabular data of each processing module, and the global item value number GVNo uniquely defined among the plural processing modules is allocated to the item value in the value list of each processing module. This information processing system executes a rearrangement processing in the following procedure.

Step 3201: The number of new records to be rearranged in each processing module is determined.

Step 3202: Based on the number of the new records, new global sequence numbers are assigned to the new records to be rearranged.

Step 3203: Each processing module sends the present global sequence numbers assigned to the current records of the processing module itself and the item values in the present value list corresponding to the present global sequence numbers to another processing module logically connected in the loop.

Step 3204: Each processing module receives, from another processing module, the present global sequence numbers of the processing module and the corresponding item values in the present value list.

Step 3205: Each processing module stores item values, as a temporary value list, corresponding to the present global sequence numbers coincident with the new global sequence numbers assigned to the new records to be rearranged in each processing module among the current global sequence numbers received from the other processing modules into a memory.

Step 3206: Each processing module creates a new pointer array which contains information specifying new item value numbers in order of the new records, and a new value list which contains the item values in the temporary value list in order of the new item value numbers.

Step 3207: Each processing module sends the new value list of each processing module to other processing modules logically connected in the loop.

Each processing module receives the new value lists of other processing modules from the other processing modules.

Each processing module compares the new value list of each processing module with the new value lists of the other processing modules, and allocates a new global item value number uniquely defined among the plural processing modules to the item value in the new value list of each processing module.

This procedure enables the data of the global information block to be rearranged.

For example, consideration is given to a case where the tabular data as shown in FIG. 14 and FIG. 15 is retrieved under the condition that “age” is 25 or lower, and the retrieval and sorting result sorted in ascending order of “age” is rearranged. FIGS. 33A to 33C are explanatory views of the tabular data after the retrieval and sorting, FIG. 33A is a data list before the retrieval and sorting, FIG. 33B is a data list after the retrieval and sorting, and FIG. 33C shows tabular data after the retrieval and sorting processing and segregated and managed.

In this example, since there are eight rows (eight records) in total, and the number of processing modules PMMs is four, two rows are arranged for each module. In the following description, although the reconfiguration relating to the item of “height” is described, with respect to other items, the reconfiguration can be performed similarly.

The data rearrangement processing is roughly divided into (procedure 1) a procedure of creating a new GOrd and OrdSet, (procedure 2) a procedure of transferring the GOrd and VL and placing them in each processing module, and (procedure 3) a procedure of compiling the VL.

Procedure 1: Since the data includes eight rows in total, and the number of modules is four, two rows are stored in each module, new GOrd and OrdSet are created in a creation destination, and value storage arrays having the same size as these are created. At this time, since the number of rows arranged in each module is known, the GOrd is obvious, and the OrdSet is also obvious in each module. Specifically, by notifying a calculation expression of data rearrangement to all processing modules, each processing module can know the GOrd.

FIGS. 34A and 34B are explanatory views of the creation processing of the GOrd and OrdSet in the data rearrangement processing.

Procedure 2: Each PMM sends the GOrd and values to another PMM. Here, the GOrd is in ascending order and is unique. Each PMM receives the GOrd and values sent from another PMM, and places the values corresponding to the GOrd matching the GOrd in the PMM itself into the value storage array. FIGS. 35A to 35C are explanatory views of the data transfer and value storage processing in the data rearrangement processing.

The data transfer can be realized in various methods. For example, between processing modules and mutually, that is, a pair of a transmission side and a reception side are determined and data may be sent, or data may be circularly sent among modules connected to one another in a loop.

Procedure 3: The value storage array created in the creation destination of each processing module is compiled, so that with respect to “height”, a pointer array VNo and a value list VL are created in each processing module, and a global item value number GVNo is allocated. For example, the PMM-0 rearranges values 172 and 168 stored in the value storage array in ascending order and creates the value list VL. In response to this, values can be set in the pointer array VNo in order of 1 and 0. When all processing modules create the value lists VL and the pointer arrays VNo similarly, next, by using the sequence number allocation processing, the global item value number GVNo can be allocated. FIG. 36 is an explanatory view of the VL compile processing in the data rearrangement processing.

Also with respect to the other items, the rearrangement processing is similarly performed, so that tabular data as shown in FIG. 37 can be obtained.

[SIMD Parallel Processing]

In the case where the parallelizing algorithm is poor, it is difficult to develop a program for obtaining a desired result by adopting the SIMD, and even if it is developed, the degree of freedom of the program is low. Then, in order to adopt the SIMD, it is necessary to develop an excellent algorithm suitable for the SIMD. In this point, in the algorithm of the embodiment, the data structure and algorithm are excellent in following points.

(1) There is no conditional branching at the execution of processing. However, in the case of the retrieval processing, although there is a possibility that the conditional branching is performed, the conditional branching is simple.

(2) Like a mutual comparison of lists in ascending order, the ratio of occupation of the processes (the number of steps, the number of clocks) executable by one instruction is high.

(3) All processing modules have equally the same role. When there are different roles for the respective processing modules, the processing can not be realized by the single instruction.

Accordingly, in this embodiment, when the SIMD is adopted, the program is simplified, and the easiness of development of the program and the high degree of freedom of the program can be ensured.

[System Structure]

The information processing system of the invention is connected through a ring-shaped channel to, for example, a terminal device as a front end, and each PMM receives an instruction from the terminal device, so that the processing of the compile, data update, or data rearrangement can be executed in the PMM. Besides, each PMM has only to send a packet by using some bus, and it is not necessary to control synchronization between among PMMs from the outside.

Besides, a control device may include, in addition to an accelerator chip including a hardware structure for repetition operation such as compiling, a general-purpose CPU. The general-purpose CPU interprets the instruction sent through the channel from the terminal device, and can give a necessary instruction to the accelerator chip.

Further, in the control device, especially in the accelerator chip therein, it is desired that a register group for containing various arrays necessary for operations, such as the sequence number array and the global sequence number array, are provided. Thus, when values necessary for a processing are loaded to the register from the memory, during the foregoing processing arithmetic operation for compiling or the like, the control device has only to read the values from the register without accessing the memory, or has only to write values into the register. In this manner, the number of times of memory access can be remarkably decreased (load before the operation processing, and writing of processing results), and the processing time can be remarkably shortened.

The invention is not limited to the above embodiments, and various modifications can be made within the scope of the invention recited in claims, and it is needless to say that those are contained in the scope of the invention.

It is noted that, in the embodiments, PMMs are connected to one another in a loop such that one side is connected by a first bus (first transmission path) to send a packet clockwise, and the other side is connected by a second bus (second transmission path) to send a packet counterclockwise. Since a delay time of packet transmission can be uniformed by the structure as stated above, it is advantageous. However, no limitation is made to this, and a transmission path of another mode, such as a bus type, may be adopted.

Besides, in the embodiments, although the PMM having the memory, the interface, and the control circuit is used, no limitation is made to this, and a personal computer, a server or the like may be used, instead of the PMM, as an information processing unit to share the local tabular data. Alternatively, a structure may be adopted such that a single personal computer or server holds plural information processing units. Also in these cases, the information processing unit receives a value indicating the order of a record, and can identify the record by referring to the global sequence number array GOrd. Besides, by referring to the global value number array, the item value can also be specified.

Besides, also with respect to the transmission path between the information processing units, the so-called network type or bus type may be adopted.

By adopting such a structure that plural information processing units are provided for a signal personal computer, the invention can be used as described below. For example, three tabular data of a Sapporo branch, a Tokyo branch, and a Fukuoka branch are prepared, and in general, retrieval, aggregation, sorting or the like is executed in the unit located at each branch. Further, global tabular data in which the three branches are integrated is considered, the tabular data of each branch is regarded as a partial table of the whole table, and retrieval, sorting and aggregation relating to the global tabular data can be realized.

Of course, also in the case where plural personal computers are connected through a network, similarly, a processing relating to local tabular data shared by the personal computers, and a processing relating to global tabular data can also be realized.

### BRIEF DESCRIPTION OF THE DRAWINGS

FIG. 1 is an explanatory view of a conventional data management mechanism.

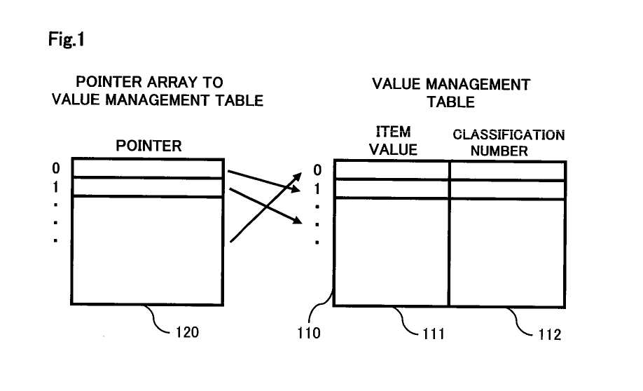

FIG. 2 is an explanatory view of a conventional data management mechanism.

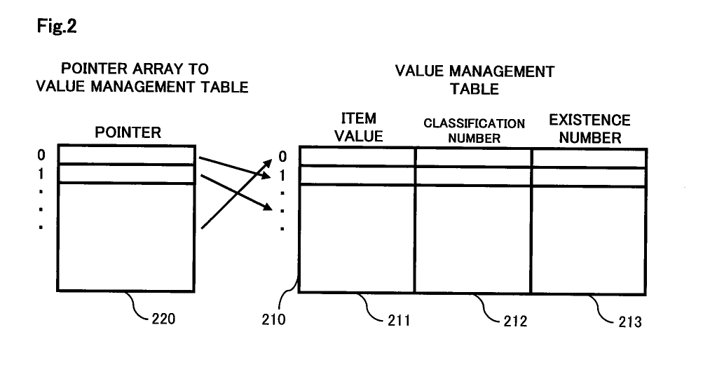

FIG. 3 is a block diagram showing an outline of an information processing system according to an embodiment of the invention.

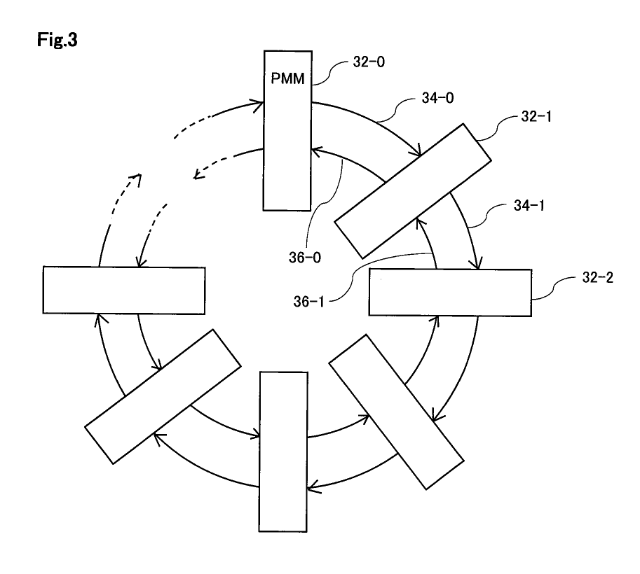

FIG. 4 is a view showing an example of a structure of a PMM according to an embodiment of the invention.

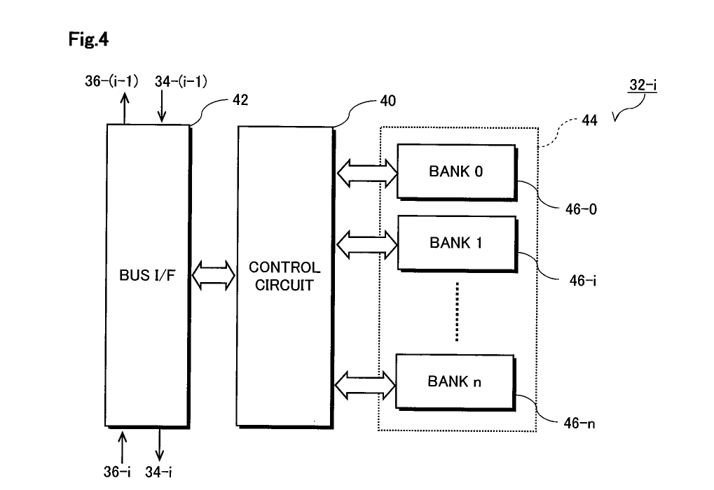

FIG. 5 is an explanatory view of an example of tabular data.

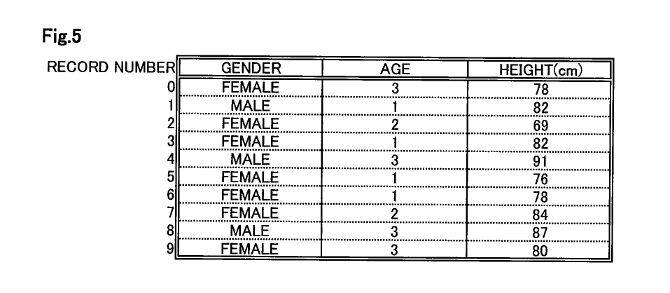

FIG. 6 is an explanatory view of a memory structure of conventional tabular data.

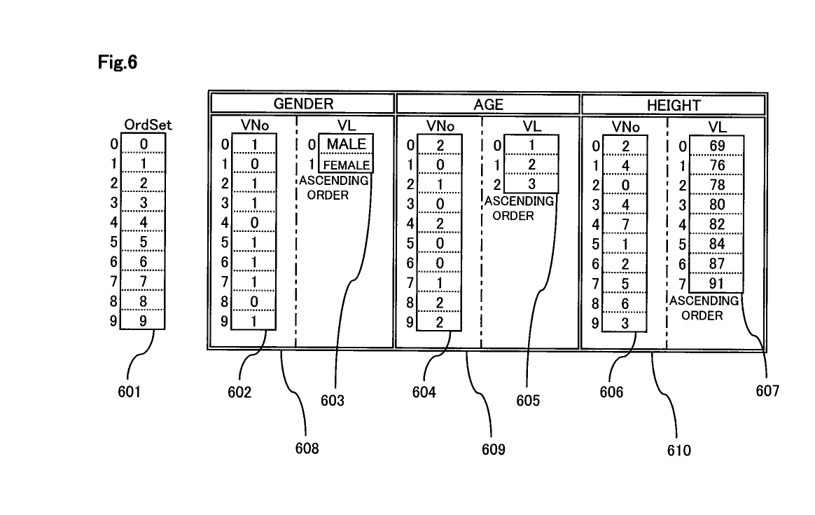

FIG. 7 is an explanatory view of an example of a memory structure of tabular data according to an embodiment of the invention.

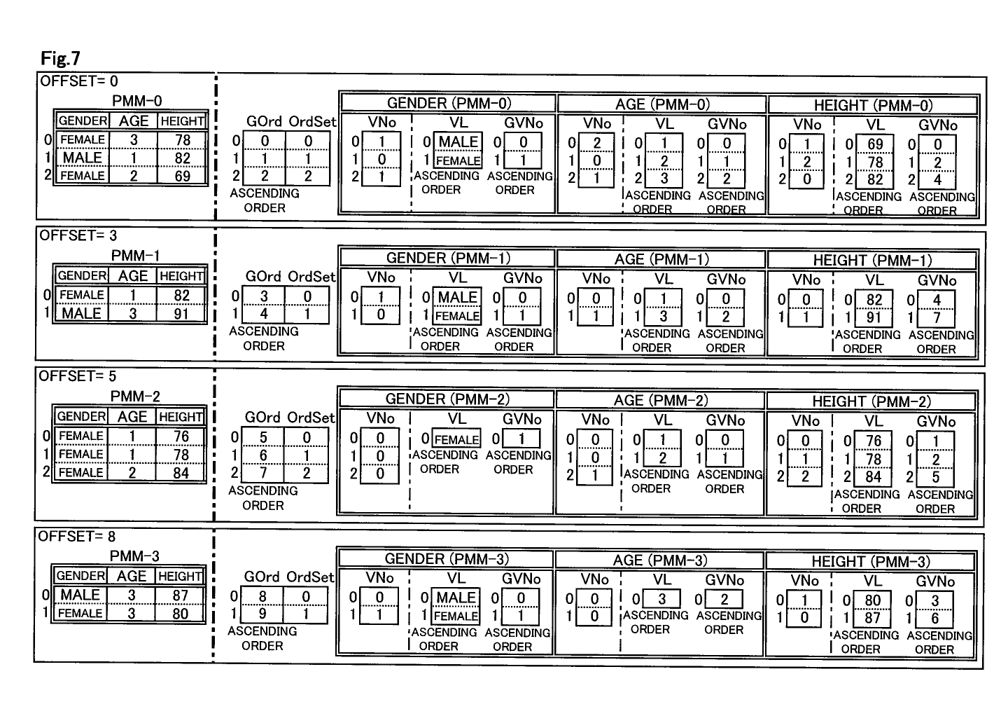

FIG. 8 is a flowchart of a sequence number allocation method according to an embodiment of the invention.

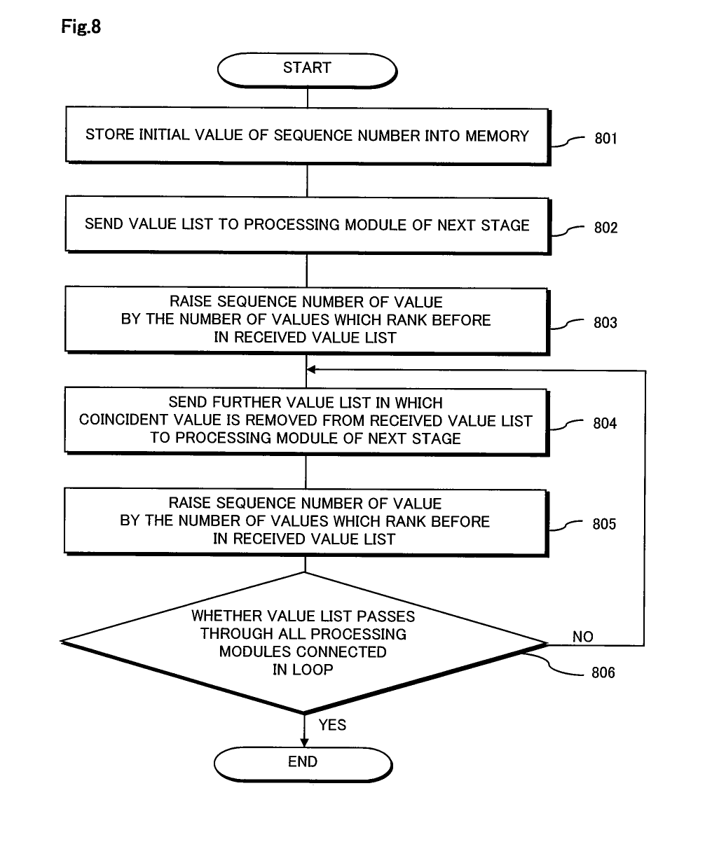

FIGS. 9A to 9D are respectively explanatory views (No. 1) of a first sequence number allocation method according to an embodiment of the invention.

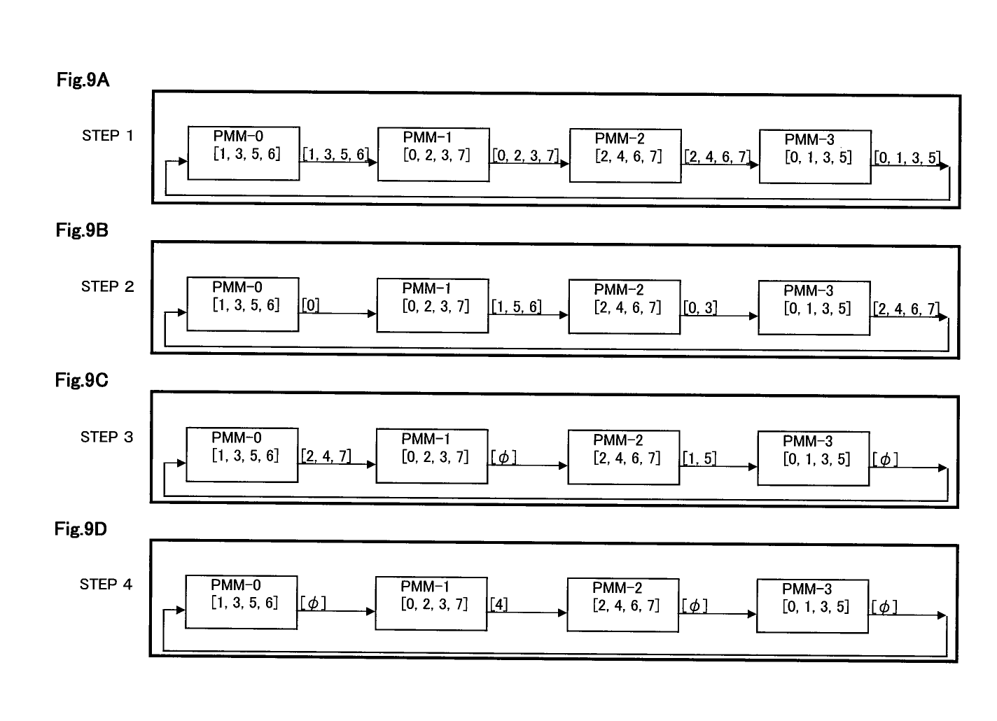

FIGS. 10A to 10D are respectively explanatory views (No. 2) of the first sequence number allocation method according to the embodiment of the invention.

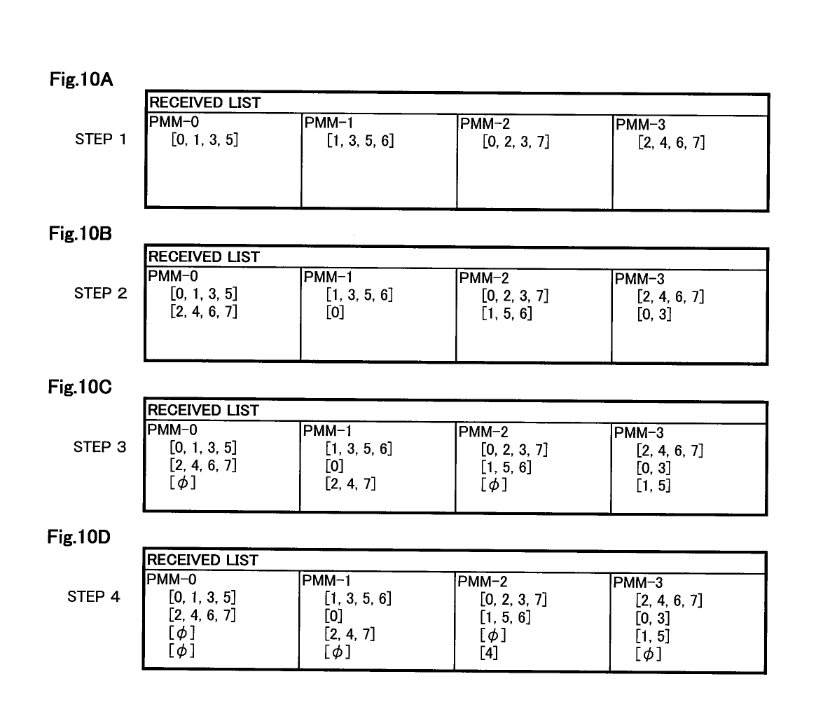

FIG. 11 is an explanatory view of a first example of a tournament device to allocate a sequence number according to an embodiment of the invention.

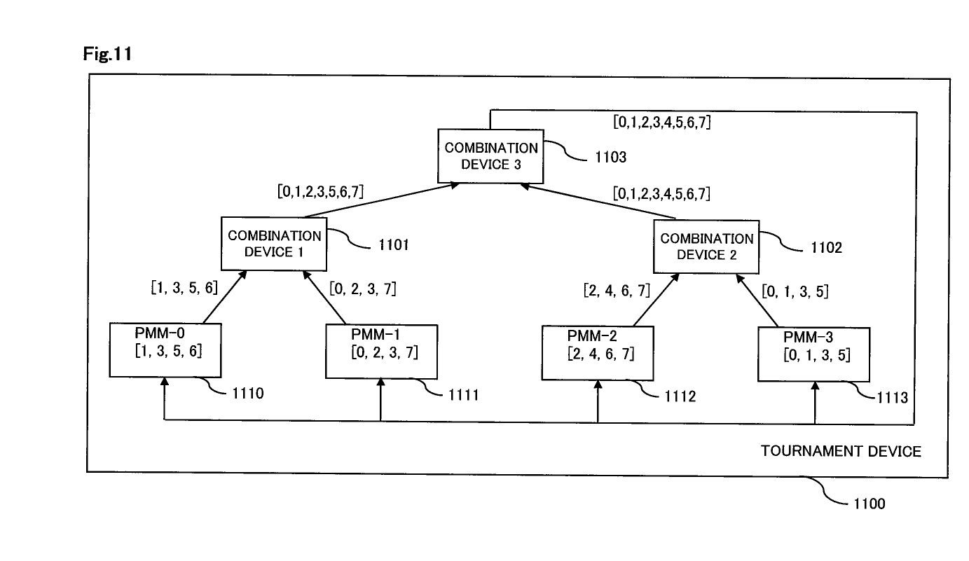

FIG. 12 is an explanatory view of a second example of the tournament device to allocate the sequence number according to the embodiment of the invention.

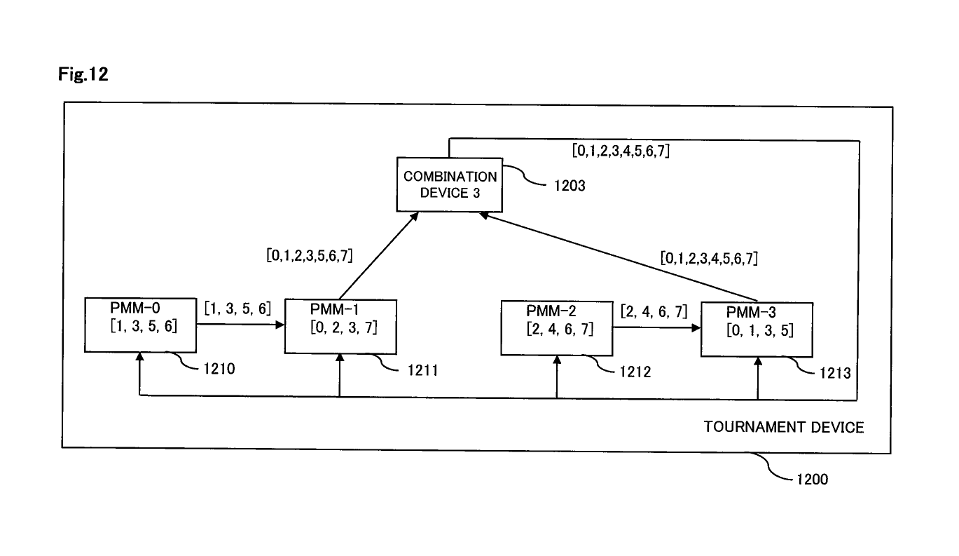

FIG. 13 is an explanatory view of a third example of the tournament device to allocate the sequence number according to the embodiment of the invention.

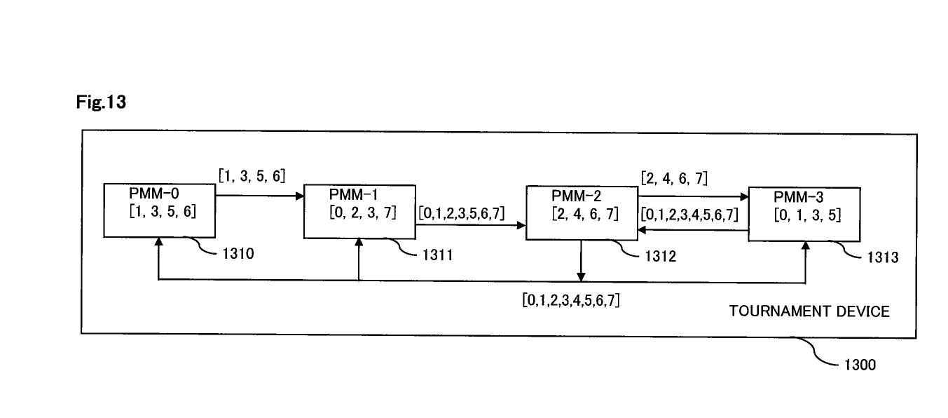

FIG. 14 is an explanatory view of tabular data managed by a single processing module.

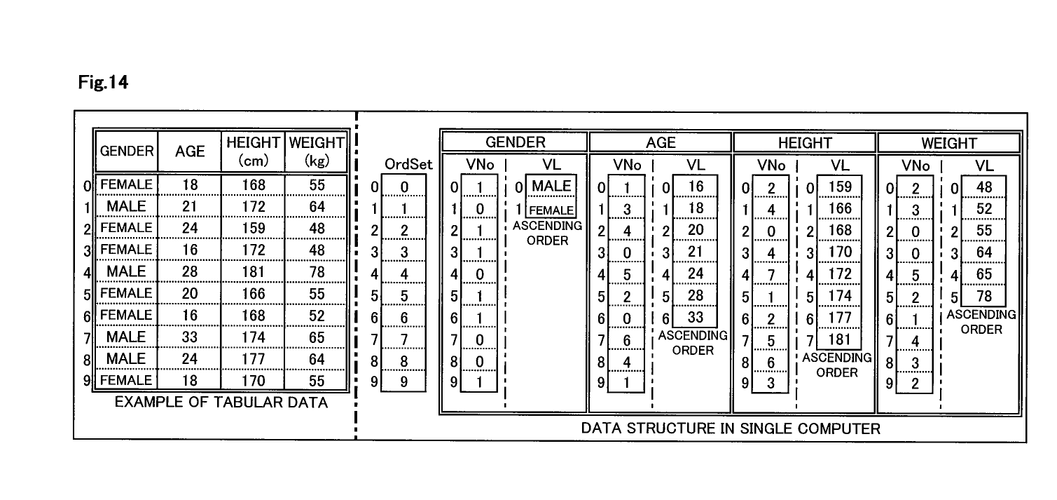

FIG. 15 is an explanatory view of tabular data divided and managed by plural processing modules.

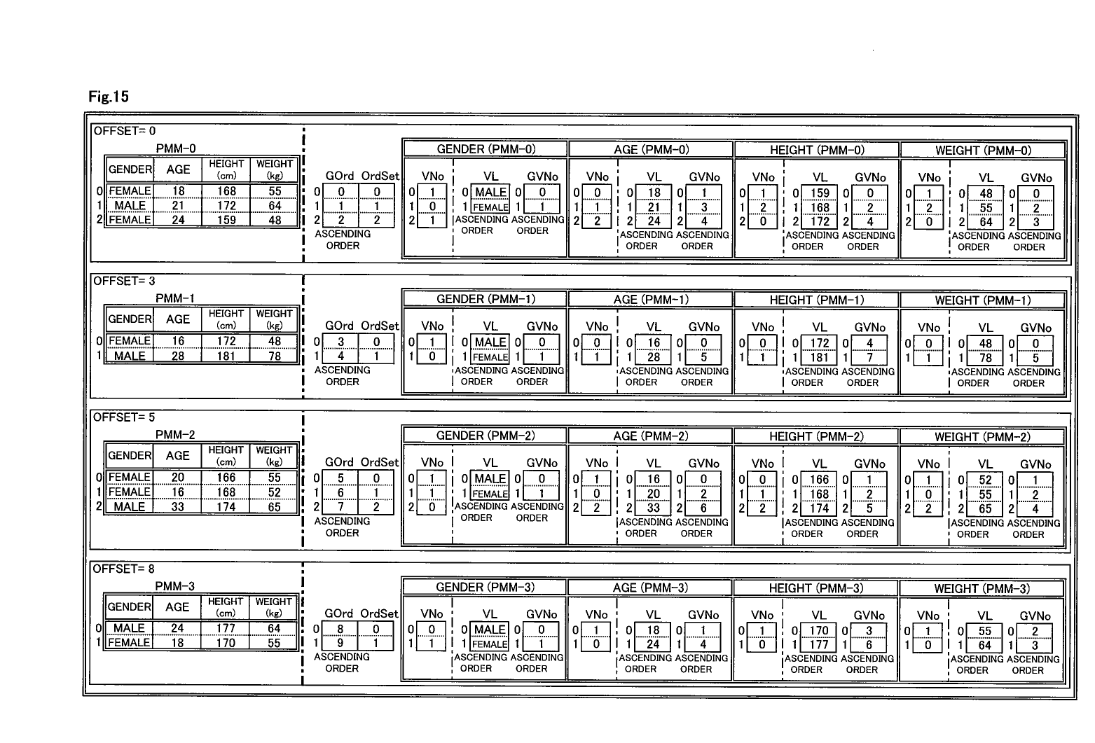

FIG. 16 is a flowchart of a compile processing according to an embodiment of the invention.

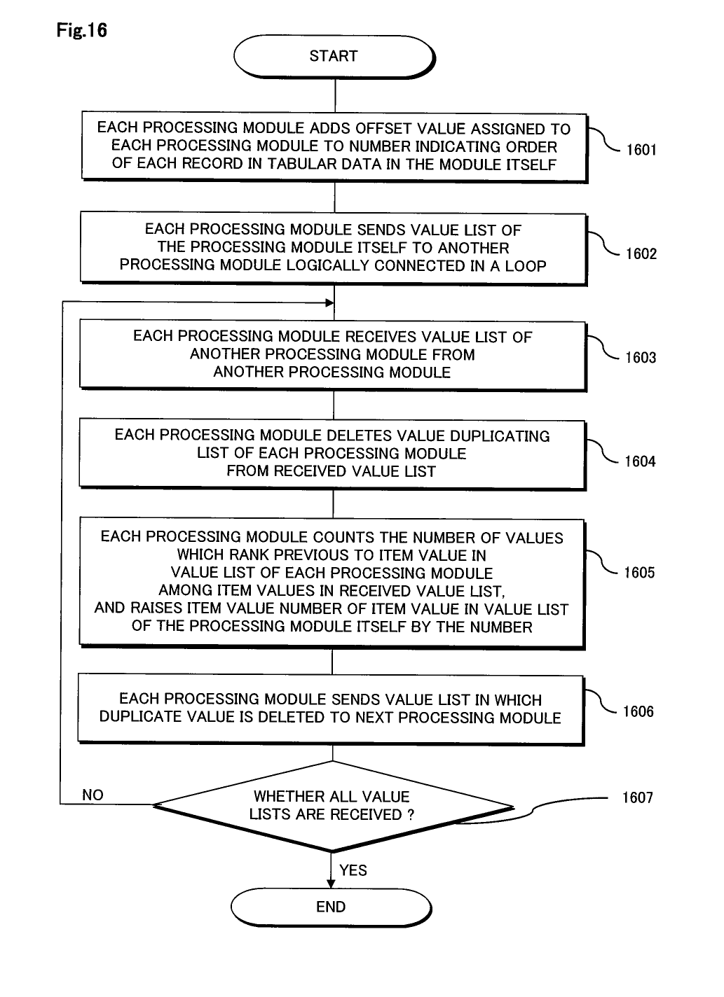

FIG. 17 is an explanatory view of tabular data as an object of a record delete processing.

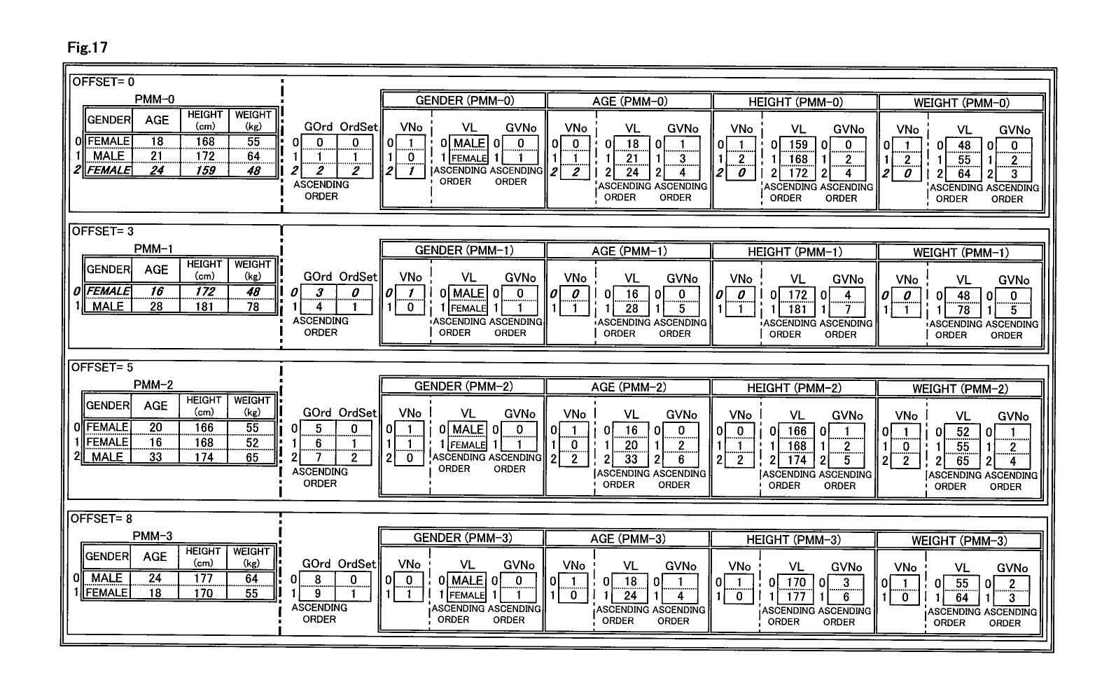

FIG. 18 is an explanatory view of an example of the record delete processing.

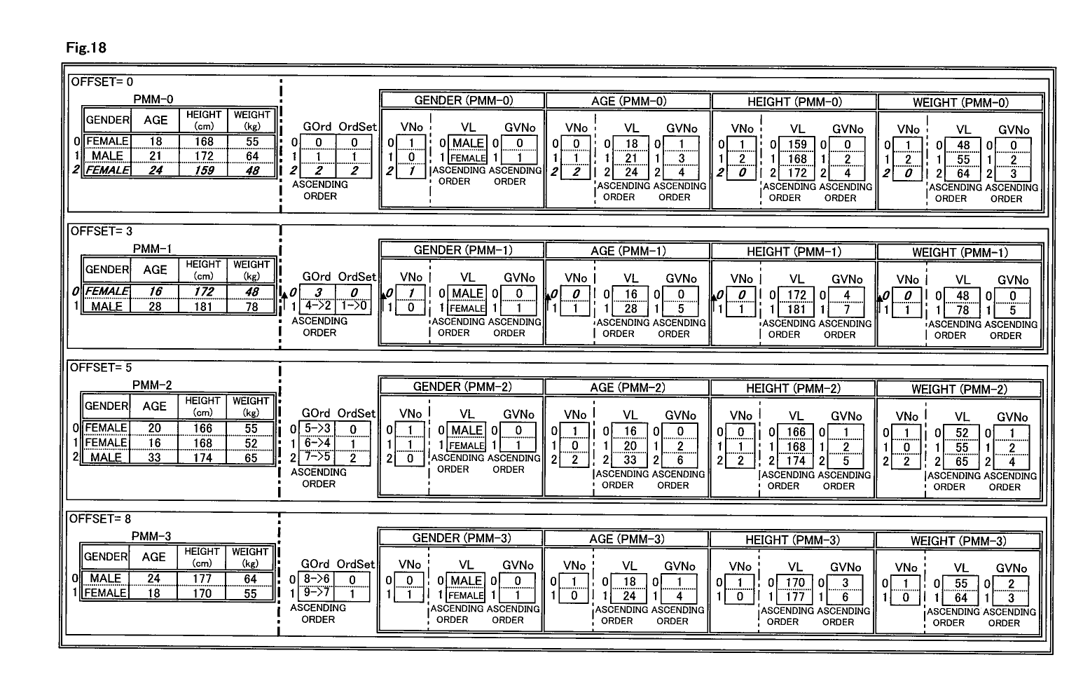

FIG. 19 is an explanatory view of tabular data after the record delete processing.

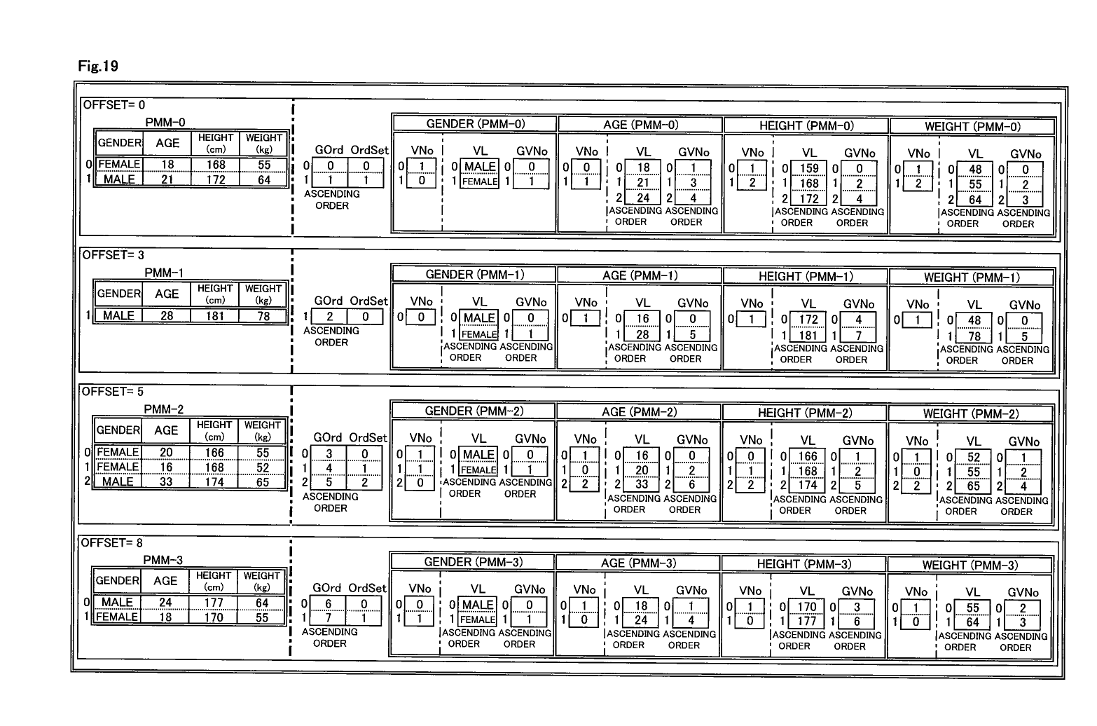

FIG. 20 is an explanatory view of an example of a record insertion processing.

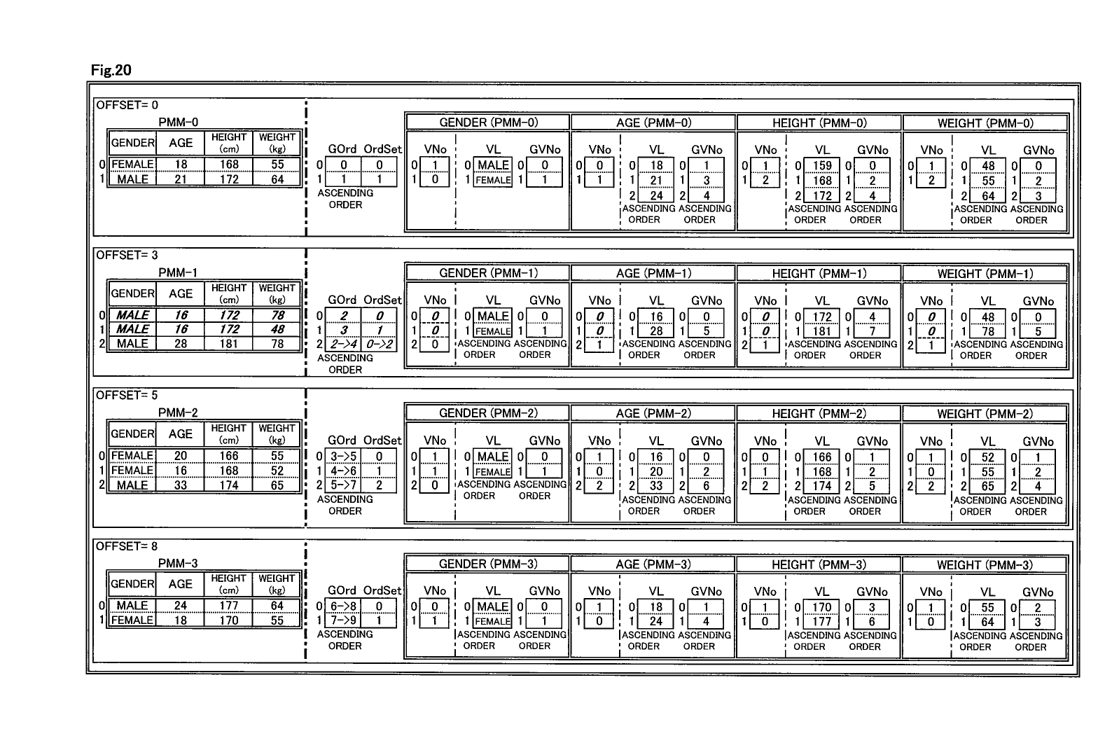

FIG. 21 is an explanatory view of tabular data after the record insertion processing.

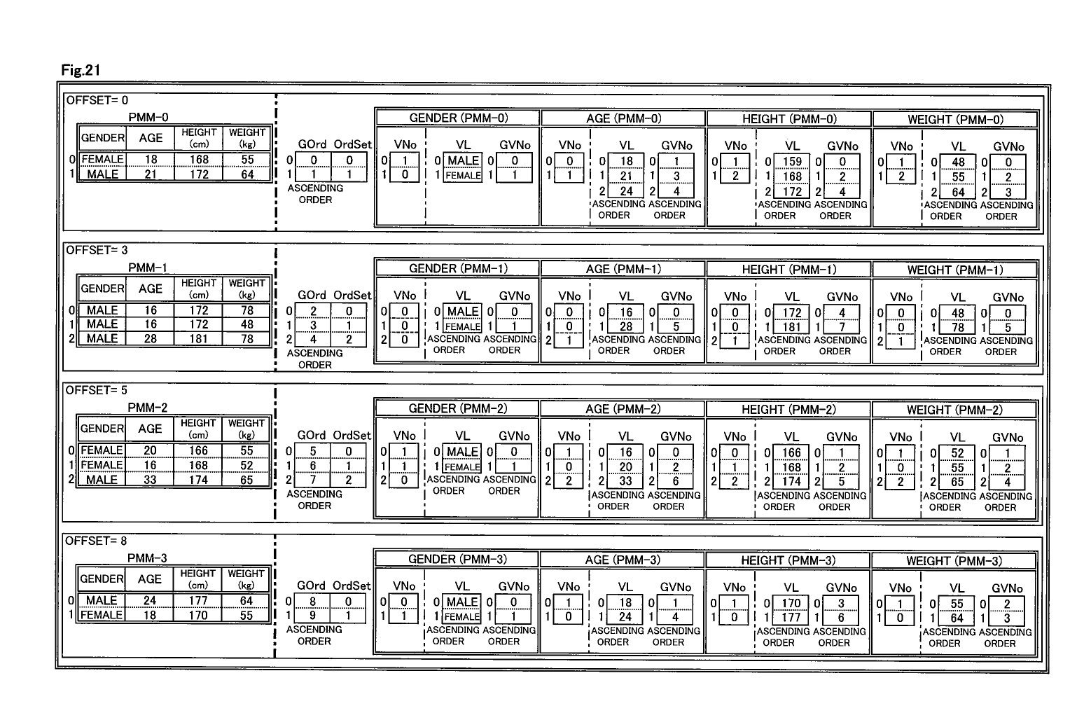

FIG. 22 is an explanatory view of an example of a data overwriting processing.

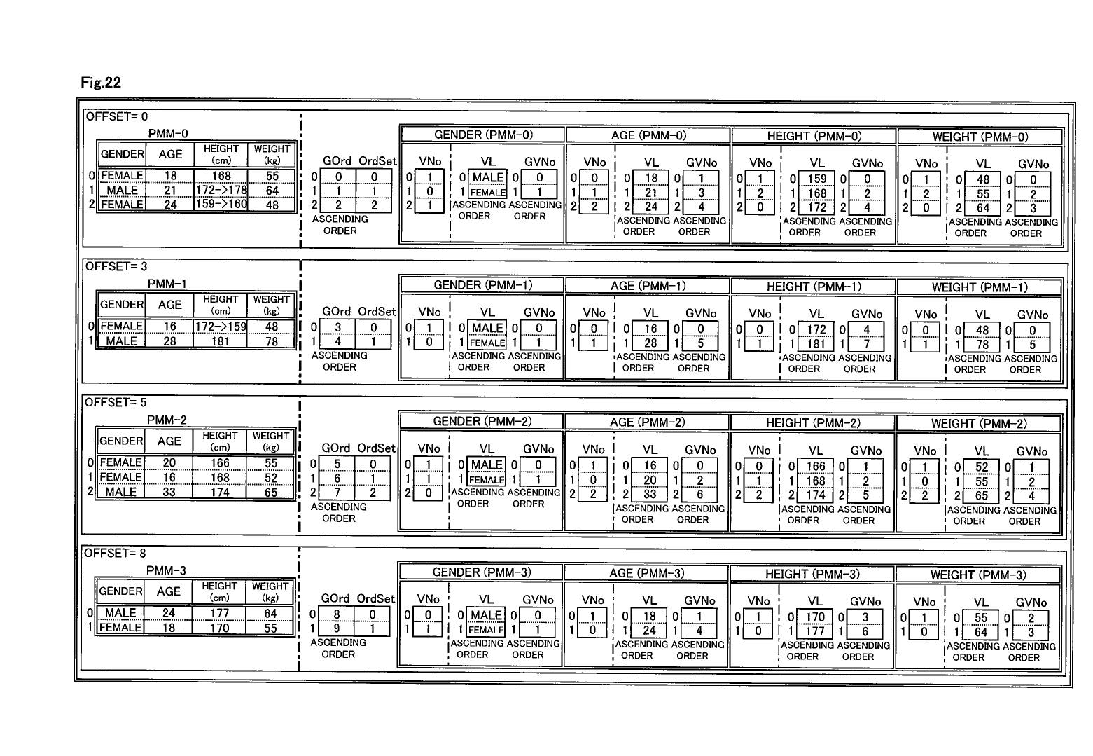

FIG. 23 is a flowchart of the data overwriting processing according to an embodiment of the invention.

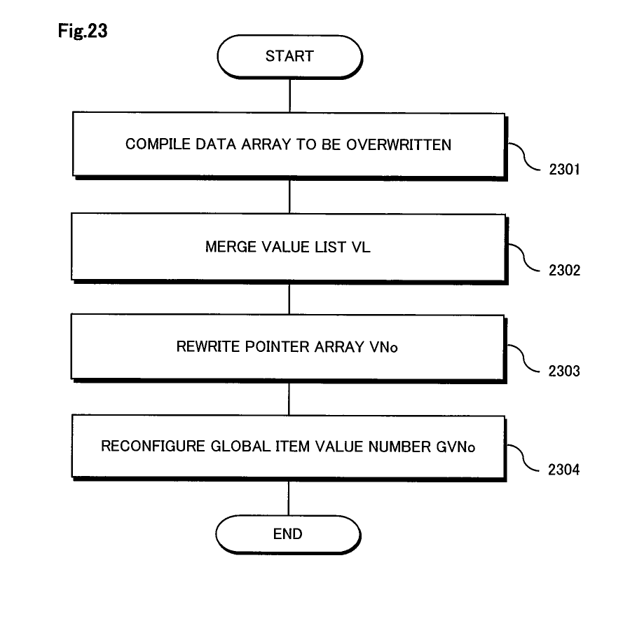

FIG. 24 is an explanatory view of a process for compiling overwriting data in a processing module.

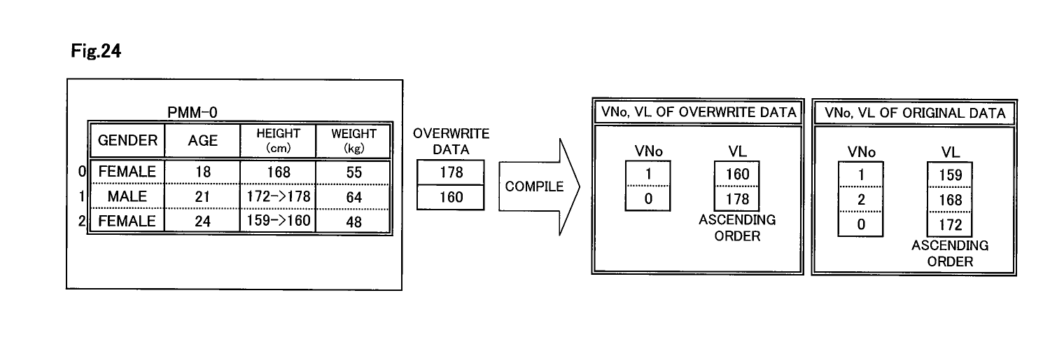

FIGS. 25A to 25D are respectively explanatory views of a processing of merging overwrite data and original data.

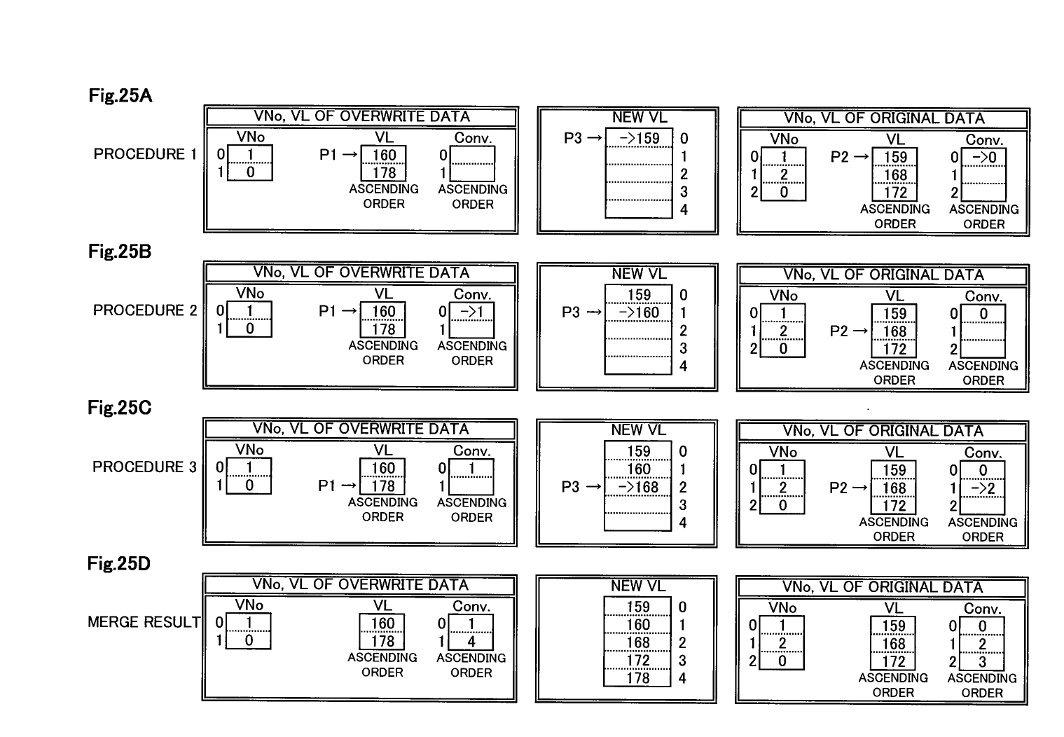

FIGS. 26A to 26C are respectively explanatory views of a processing of updating a pointer array.

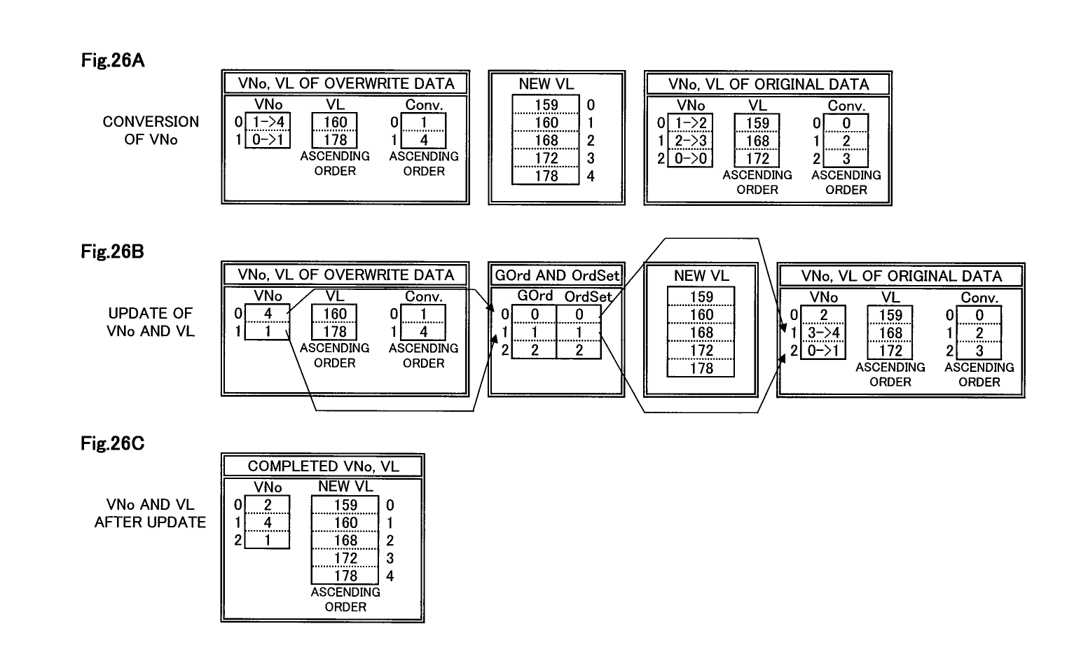

FIG. 27 is an explanatory view of tabular data during a data overwriting processing.

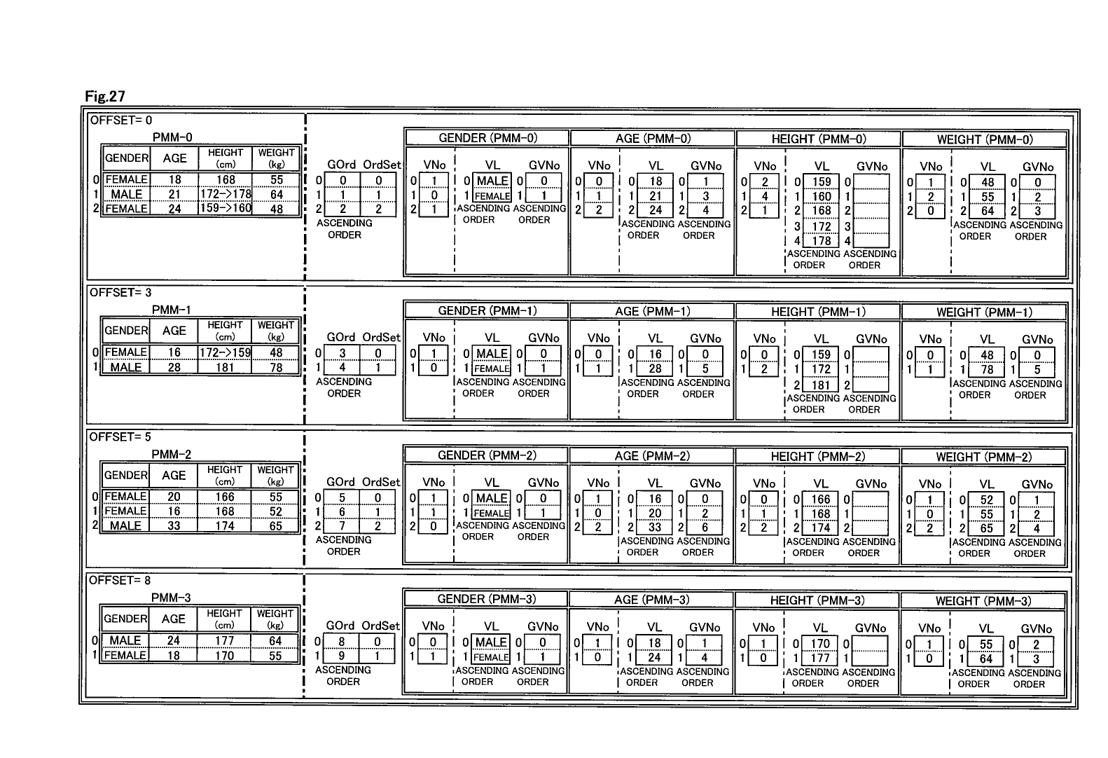

FIG. 28 is an explanatory view of the tabular data after the data overwriting processing.

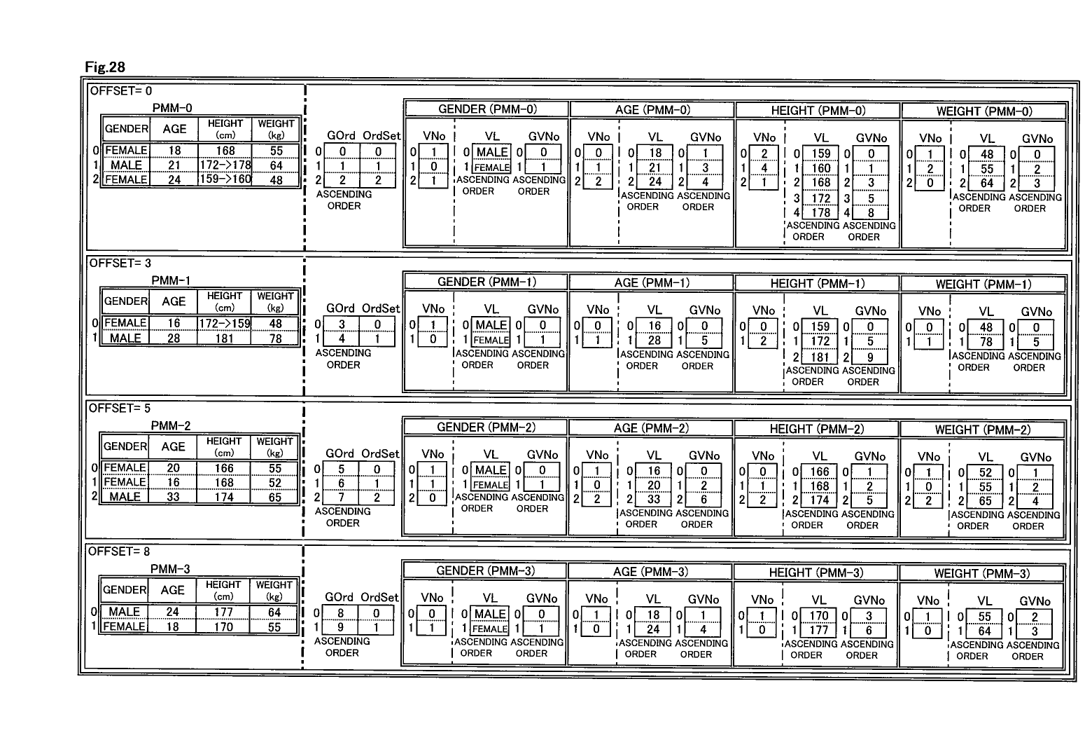

FIGS. 29A and 29B are explanatory views of a sweep processing according to an embodiment of the invention.

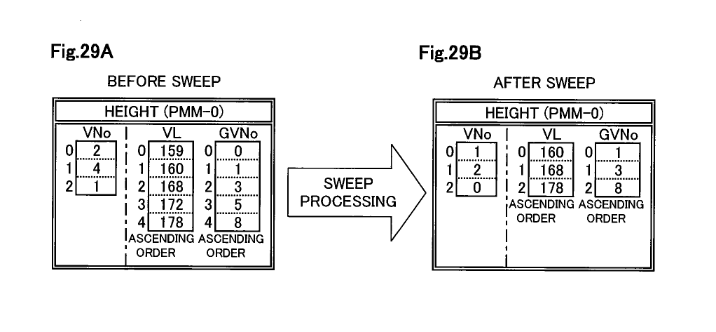

FIG. 30 is a flowchart of the sweep processing according to the embodiment of the invention.

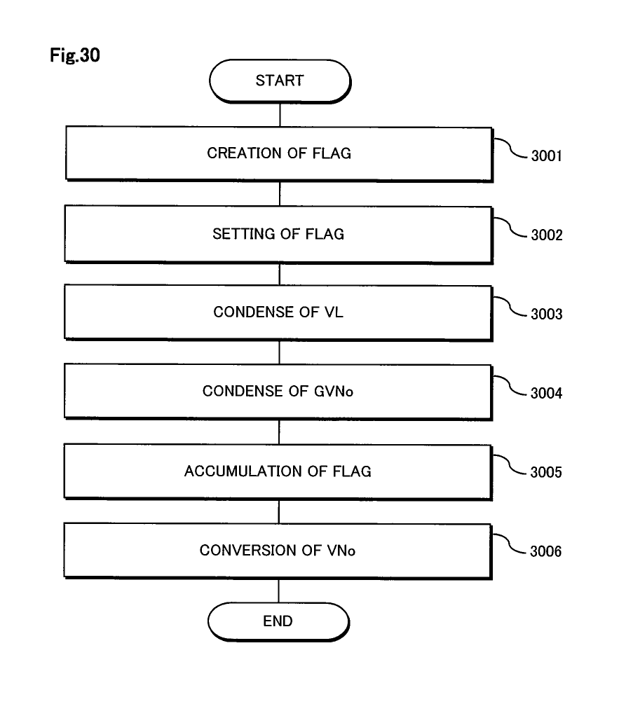

FIGS. 31A to 31H are explanatory views of an example of proceeding states of the sweep processing.

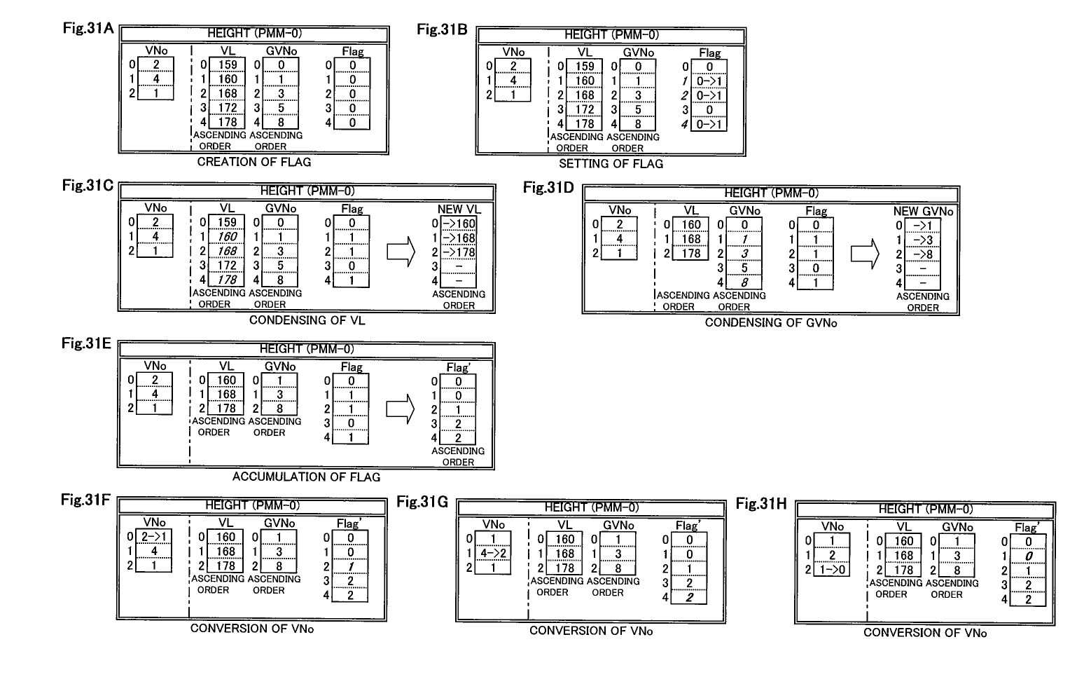

FIG. 32 is a flowchart of a data rearrangement processing according to an embodiment of the invention.

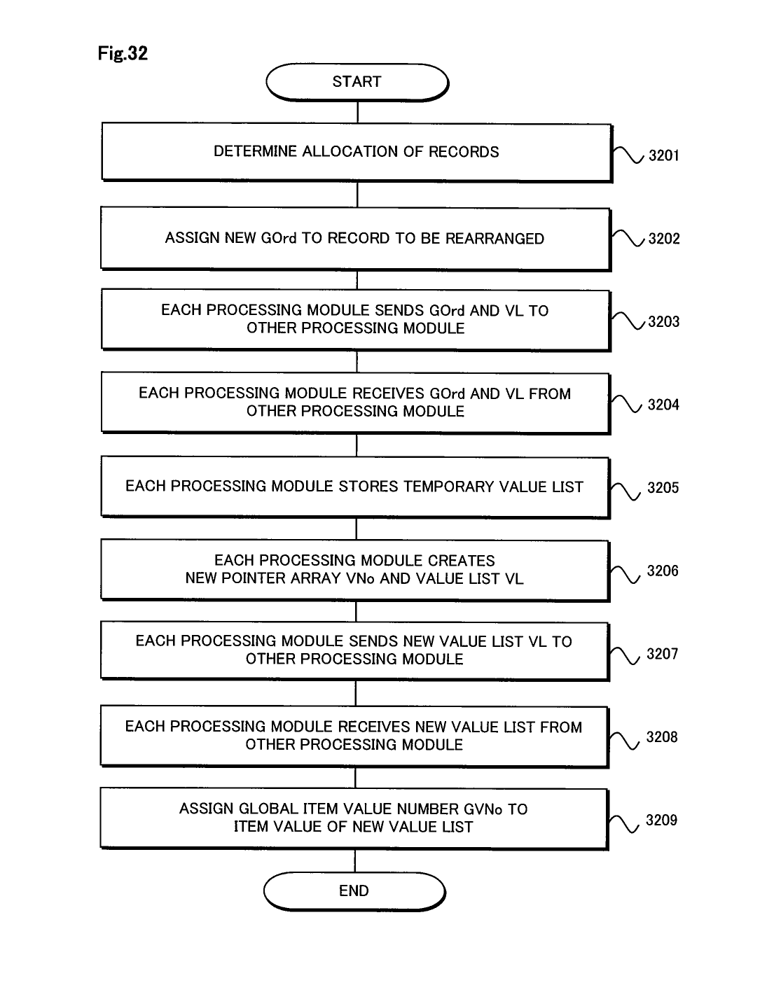

FIGS. 33A to 33C are explanatory views of tabular data after a retrieval and sort processing, which is divided and managed.

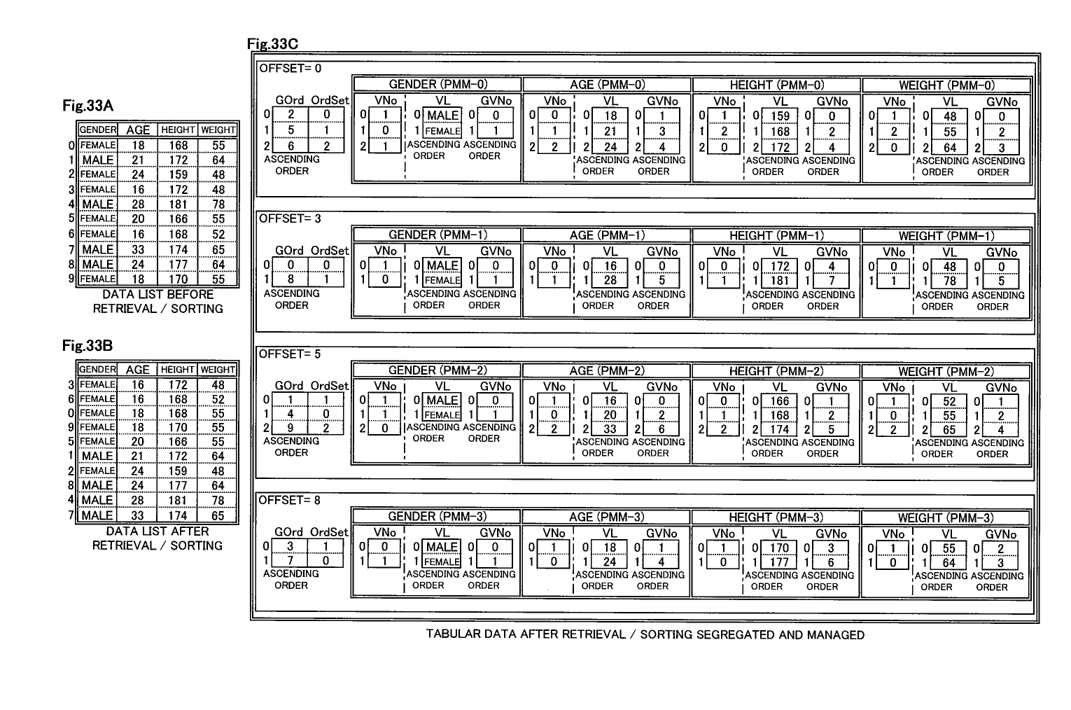

FIGS. 34A and 34B are explanatory views of a creation processing of GOrd and OrdSet in a data rearrangement processing.

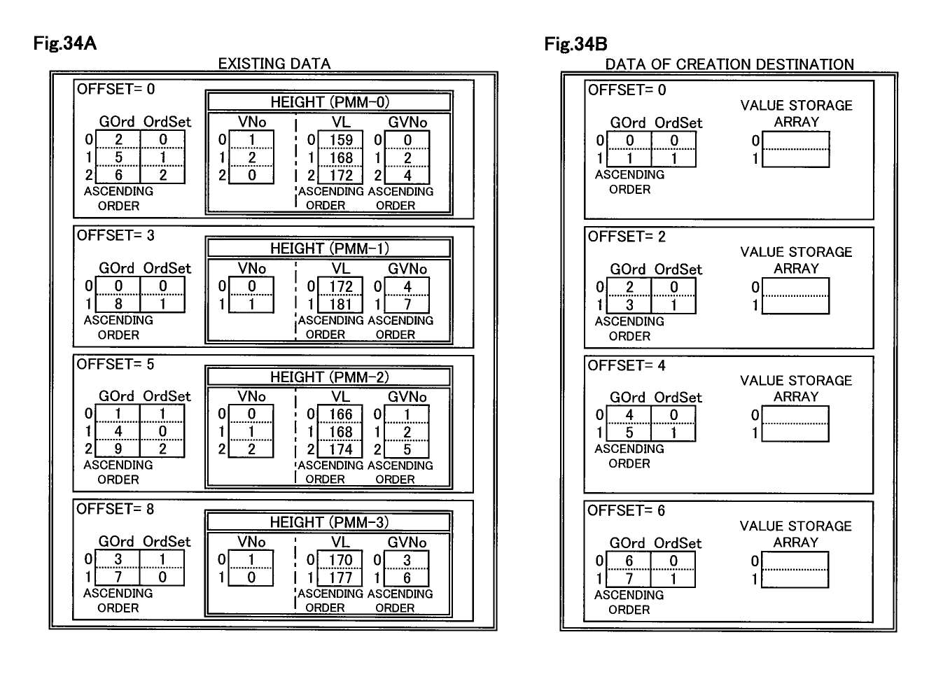

FIGS. 35A to 35C are explanatory views of data transfer and a value storage processing in the data rearrangement processing.

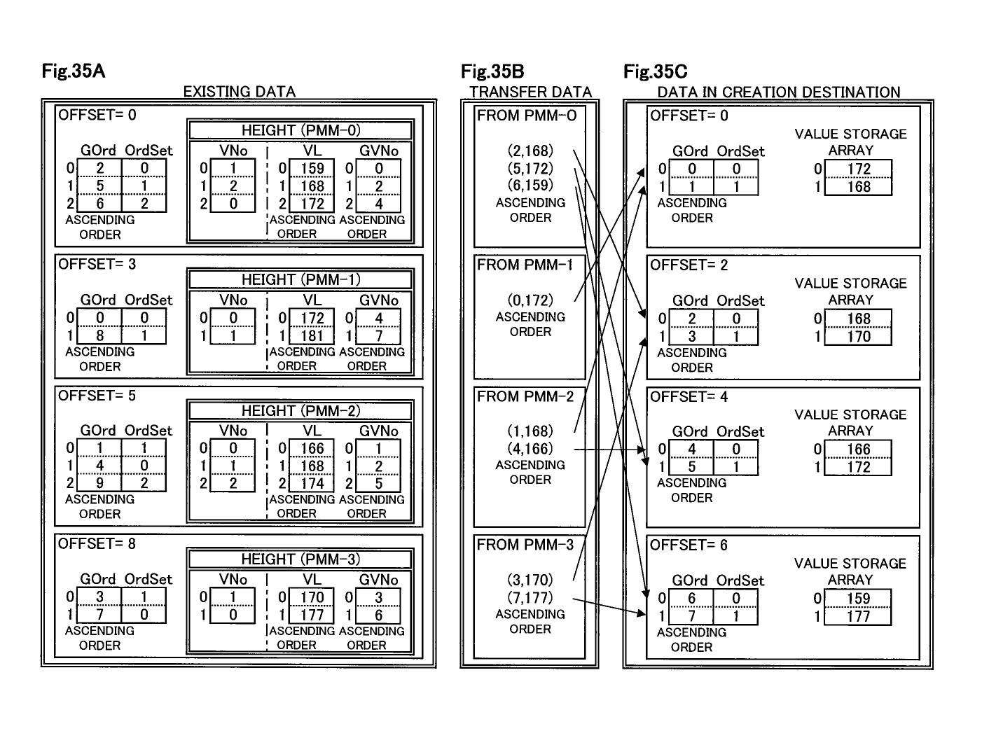

FIG. 36 is an explanatory view of a VL compile processing in the data rearrangement processing.

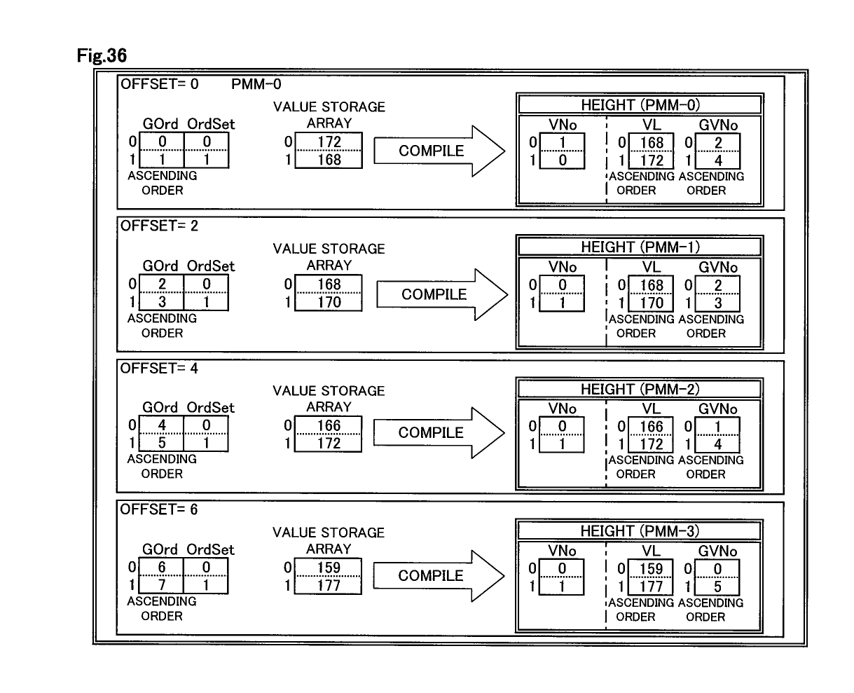

FIG. 37 is an explanatory view of tabular data after the data rearrangement processing.

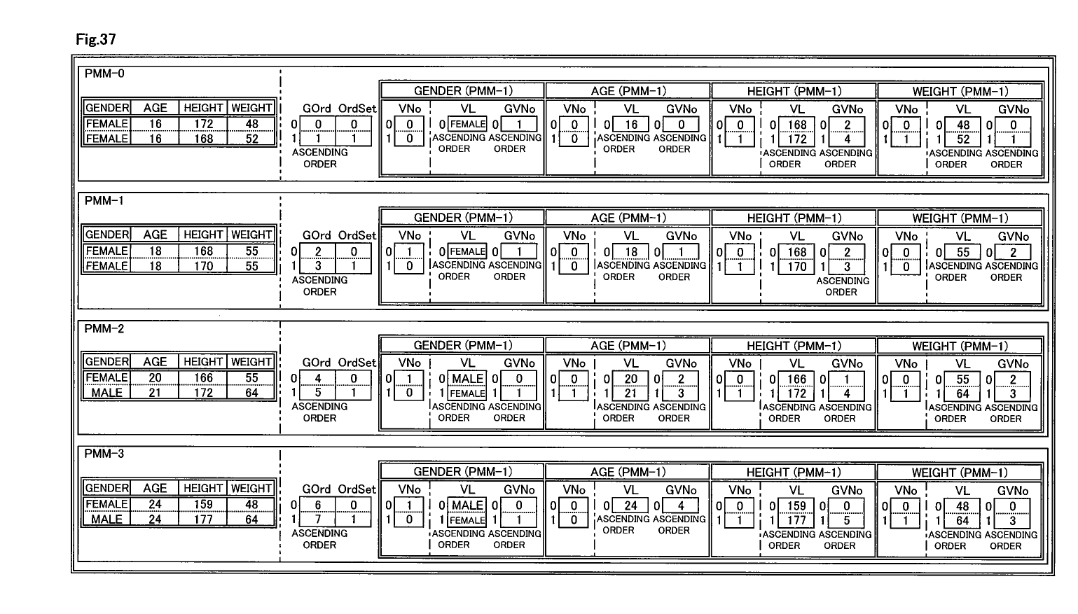

### DESIGNATION OF REFERENCE NUMERALS AND SIGNS

32 PMM
34 first bus
36 second bus
40 control circuit
42 bus I/F
44 memory
46 bank

1-21. (canceled)

22. An information processing method for building a global information block in an information processing system having a plurality of processing modules logically connected to one another in a loop, in which
each processing module includes a memory to store a local information block representing tabular data, and
the local information block includes a pointer array which contains information specifying item value numbers in order of records in the tabular data and a value list which contains item values in the tabular data in order of the item value numbers corresponding to the item values, the method comprising the steps of:
assigning a global sequence number uniquely defined among the plurality of processing modules to the record in the tabular data for each processing module by adding an offset value assigned to each processing module to a number indicating the order of the record in the tabular data for each processing module, and
allocating a global item value number uniquely defined among the plurality of processing modules to the item value in the value list for each processing module by sending the value list from each processing module to other processing modules logically connected in the loop, receiving the value lists from the other processing modules to each processing module, calculating a count of the item values which are included in the value lists received from the other processing modules and rank previous to the item value in the value list for each processing module, and raising the item value numbers in the value list for each processing module by the count.

23. An information processing method for deleting data from a global information block in an information processing system having a plurality of processing modules logically connected to one another in a loop, in which
each processing module includes a memory to store a local information block representing tabular data,
the local information block includes a pointer array which contains information specifying item value numbers in order of records in the tabular data and a value list which contains item values in the tabular data in order of the item value numbers corresponding to the item values,
the records in the tabular data for each processing module are assigned respective global sequence numbers uniquely defined among the plurality of processing modules, and
global item value numbers uniquely defined among the plurality of processing modules are allocated to the respective item values in the value list for each processing module, the method comprising the steps of:
identifying records to be deleted; and
lowering the global sequence numbers which rank subsequent to the global sequence numbers assigned to the records to be deleted by a count of the records to be deleted and deleting the information specifying the item value numbers corresponding to the records to be deleted from the pointer array.

24. An information processing method for inserting data into a global information block in an information processing system having a plurality of processing modules logically connected to one another in a loop, in which
each processing module includes a memory to store a local information block representing tabular data,
the local information block includes a pointer array which contains information specifying item value numbers in order of records in the tabular data and a value list which contains item values in the tabular data in order of the item value numbers corresponding to the item values,
the records in the tabular data for each processing module are assigned respective global sequence numbers uniquely defined among the plurality of processing modules, and
global item value numbers uniquely defined among the plurality of processing modules are allocated to the respective item values in the value list for each processing module, the method comprising the steps of:
identifying insertion locations of records to be inserted; and
raising the global sequence numbers which rank subsequent to the global sequence numbers assigned to the records to be inserted by a count of the records to be inserted and reserving areas at respective locations in the pointer array, the areas being where the information specifying the item value numbers corresponding to the records to be inserted is stored.

25. An information processing method for overwriting data in a global information block in an information processing system having a plurality of processing modules logically connected to one another in a loop, in which
each processing module includes a memory to store a local information block representing tabular data,
the local information block includes a pointer array which contains information specifying item value numbers in order of records in the tabular data, and a value list which contains item values in the tabular data in order of the item value numbers corresponding to the item values,
the records in the tabular data of each processing module are assigned respective global sequence numbers uniquely defined among the plurality of processing modules, and
global item value numbers uniquely defined among the plurality of processing modules are allocated to the respective item values in the value list for each processing module, the method comprising the steps of:
identifying records to be overwritten and setting overwrite data with which the records are to be overwritten;
creating pairs of item value numbers and item values representing the overwrite data;
updating the pointer array and the value list in the local information block including the records to be overwritten by merging the created pairs of the item value numbers and the item values; and
allocating new global item value numbers among the plurality of the processing modules to the respective item values in the value list for each processing module by sending the value list from each processing module to other processing modules logically connected in the loop, receiving the value lists from the other processing modules to each processing module, and comparing the value list for each processing module with the value lists from the other processing modules.

26. An information processing method for deleting unnecessary data from a global information block in an information processing system having a plurality of processing modules logically connected to one another in a loop, in which
each processing module includes a memory to store a local information block representing tabular data,
the local information block includes a pointer array which contains information specifying item value numbers in order of records in the tabular data, and a value list which contains item values in the tabular data in order of the item value numbers corresponding to the item values,
the records in the tabular data for each processing module are assigned respective global sequence numbers uniquely defined among the plurality of processing modules, and
global item value numbers uniquely defined among the plurality of processing modules are allocated to the respective item values in the value list for each processing module, the method comprising the steps of:
updating the value list so that the item value corresponding to a current item value number specified by an element of a current pointer array, the item value being one of the item values stored in the value list of the local information block, is stored in order of the current item value number; and
updating the information specifying the current item value number stored in the current pointer array so as to specify the item value stored in the updated value list.

27. An information processing method for rearranging data of a global information block in an information processing system having a plurality of processing modules logically connected to one another in a loop, in which
each processing modules includes a memory to store a local information block representing tabular data,
the local information block includes a pointer array which contains information specifying item value numbers in order of records in the tabular data, and a value list which contains item values in the tabular data in order of the item value numbers corresponding to the item values,
the records in the tabular data for each processing module are assigned global sequence numbers uniquely defined among the plurality of processing modules, and
global item value numbers uniquely defined among the plurality of processing modules are allocated to the respective item values in the value list for each processing module, the method comprising the steps of:
determining a number of new records to be rearranged in each processing module;:
assigning new global sequence numbers to the respective new records to be rearranged based on the number of the new records;
sending a current global sequence number assigned to a current record in each processing module and the item value, that is corresponding to the current global sequence number, in a current value list from each processing module to other processing modules logically connected in the loop,
receiving the current global sequence number in the other processing modules and the corresponding item value in the current value list from the other processing modules to each processing module,
storing the item value corresponding to the current global sequence number equal to the new current sequence number assigned to the new record to be rearranged in each processing module as a temporary value list into the memory, said current global sequence number being one of the current global sequence numbers received from the other processing modules,
creating a new pointer array and a new value list in each processing module, the new pointer array containing information specifying new item value numbers in order of the new records and the new value list containing the item values from the temporary value list in order of the new item value numbers,
sending the new value list from each processing module to the other processing modules logically connected in the loop,
receiving the new value lists of the other processing modules from the other processing modules to each processing module, and
comparing the new value list in each processing modules with the new value lists from the other processing modules and allocating a new global item value number uniquely defined among the plurality of processing modules to the item value in the new value, list for each processing modules.

28. A program for causing a computer in each processing module to perform the steps in an information processing system having a plurality of processing modules logically connected to one another in a loop, in which
each processing module includes a memory to store a local information block representing tabular data, and
the local information block includes a pointer array which contains information specifying item value numbers in order of records in the tabular data and a value list which contains item values in the tabular data in order of the item value numbers corresponding to the item values, the steps comprising:
assigning a global sequence number uniquely defined among the plurality of processing modules to the record in the tabular data for each processing module by adding an offset value assigned to each processing module to a number indicating the order of the record in the tabular data for each processing module, and
allocating a global item value number uniquely defined among the plurality of processing modules to the item value in the value list for each processing module by sending the value list from each processing module to other processing modules logically connected in the loop, receiving the value lists from the other processing modules to each processing module, calculating a count of the item values which are included in the value lists received from the other processing modules and rank previous to the item value in the value list for each processing module, and raising the item value numbers in the value list for each processing module by the count.

29. A program for causing a computer in each processing module to perform the steps in an information processing system having a plurality of processing modules logically connected to one another in a loop, in which
each processing module includes a memory to store a local information block representing tabular data,
the local information block includes a pointer array which contains information specifying item value numbers in order of records in the tabular data and a value list which contains item values in the tabular data in order of the item value numbers corresponding to the item values,
the records in the tabular data for each processing module are assigned respective global sequence numbers uniquely defined among the plurality of processing modules, and
global item value numbers uniquely defined among the plurality of processing modules are allocated to the respective item values in the value list for each processing module, the steps comprising:
identifying records to be deleted; and
lowering the global sequence numbers which rank subsequent to the global sequence numbers assigned to the records to be deleted by a count of the records to be deleted and deleting the information specifying the item value numbers corresponding to the records to be deleted from the pointer array.

30. A program for causing a computer in each processor to perform the steps in an information processing system having a plurality of processing modules logically connected to one another in a loop, in which
each processing module includes a memory to store a local information block representing tabular data,
the local information block includes a pointer array which contains information specifying item value numbers in order of records in the tabular data and a value list which contains item values in the tabular data in order of the item value numbers corresponding to the item values,
the records in the tabular data for each processing module are assigned respective global sequence numbers uniquely defined among the plurality of processing modules, and
global item value numbers uniquely defined among the plurality of processing modules are allocated to the respective item values in the value list for each processing module, the steps comprising:
identifying insertion locations of records to be inserted; and
raising the global sequence numbers which rank subsequent to the global sequence numbers assigned to the records to be inserted by a count of the records to be inserted and reserving areas at respective locations in the pointer array, the areas being where the information specifying the item value numbers corresponding to the records to be inserted is stored.

31. A program for causing a computer in each processing module to perform the steps in an information processing system having a plurality of processing modules logically connected to one another in a loop, in which
each processing module includes a memory to store a local information block representing tabular data,
the local information block includes a pointer array which contains information specifying item value numbers in order of records in the tabular data, and a value list which contains item values in the tabular data in order of the item value numbers corresponding to, the item values,
the records in the tabular data of each processing module are assigned respective global sequence numbers uniquely defined among the plurality of processing modules, and
global item value numbers uniquely defined among the plurality of processing modules are allocated to the respective item values in the value list for each processing module, the steps comprising:
identifying records to be overwritten and setting overwrite data with which the records are to be overwritten;
creating pairs of item value numbers and item values representing the overwrite data;
updating the pointer array and the value list in the local information block including the records to be overwritten by merging the created pairs of the item value numbers and the item values; and
allocating new global item value numbers among the plurality of the processing modules to the respective item values in the value list for each processing module by sending the value list from each processing module to other processing modules logically connected in the loop, receiving the value lists from the other processing modules to each processing module, and comparing the value list for each processing module with the value lists from the other processing modules.

32. A program for causing a computer in each processing module to perform the steps in an information processing system having a plurality of processing modules logically connected to one another in a loop, in which
each processing module includes a memory to store a local information block representing tabular data,
the local information block includes a pointer array which contains information specifying item value numbers in order of records in the tabular data, and a value list which contains item values in the tabular data in order of the item value numbers corresponding to the item values,
the records in the tabular data for each processing module are assigned respective global sequence numbers uniquely defined among the plurality of processing modules, and
global item value numbers uniquely defined among the plurality of processing modules are allocated to the respective item values in the value list for each processing module, the steps comprising:
updating the value list so that the item value corresponding to a current item value number specified by an element of a current pointer array, the item value being one of the item values stored in the value list of the local information block, is stored in order of the current item value number; and
updating the information specifying the current item value number stored in the current pointer array so as to specify the item value stored in the updated value list.

33. A program for causing a computer in each processing module to perform the steps in an information processing system having a plurality of processing modules logically connected to one another in a loop, in which
each processing modules includes a memory to store a local information block representing tabular data,
the local information block includes a pointer array which contains information specifying item value numbers in order of records in the tabular data, and a value list which contains item values in the tabular data in order of the item value numbers corresponding to the item values,
the records in the tabular data for each processing module are assigned global sequence numbers uniquely defined among the plurality of processing modules, and
global item value numbers uniquely defined among the plurality of processing modules are allocated to the respective item values in the value list for each processing module, the steps comprising:
determining a number of new records to be rearranged in each processing module;
assigning new global sequence numbers to the respective new records to be rearranged based on the number of the new records;
sending a current global sequence number assigned to a current record in each processing module and the item value, that is corresponding to the current global sequence number, in a current value list from each processing module to other processing modules logically connected in the loop,
receiving the current global sequence number in the other processing modules and the corresponding item value in the current value list from the other processing modules to each processing module,
storing the item value corresponding to the current global sequence number equal to the new current sequence number assigned to the new record to be rearranged in each processing module as a temporary value list into the memory, said current global sequence number being one of the current global sequence numbers received from the other processing modules,
creating a new pointer array and a new value list in each processing module, the new pointer array containing information specifying new item value numbers in order of the new records and the new value list containing the item values from the temporary value list in order of the new item value numbers,
sending the new value list from each processing module to the other processing modules logically connected in the loop,
receiving the new value lists of the other processing modules from the other processing modules to each processing module, and
comparing the new value list in each processing modules with the new value lists from the other processing modules and allocating a new global item value number uniquely defined among the plurality of processing modules to the item value in the new value list for each processing modules.

34. A computer readable recording medium in which a program according to claim 28 is stored.

35. A computer readable recording medium in which a program according to claim 29 is stored.

36. A computer readable recording medium in which a program according to claim 30 is stored.

37. A computer readable recording medium in which a program according to claim 31 is stored.

38. A computer readable recording medium in which a program according to claim 32 is stored.

39. A computer readable recording medium in which a program according to claim 33 is stored.

40. An information processing system having a plurality of processing modules logically connected to one another in a loop, in which each processing module includes a memory to store a local information block representing tabular data, and
the local information block includes a pointer array which contains information specifying item value numbers in order of records in the tabular data and a value list which contains item values in the tabular data in order of the item value numbers corresponding to the item values, wherein each processing module comprises:
means for assigning a global sequence number uniquely defined among the plurality of processing modules to the record in the tabular data for each processing module by adding an offset value assigned to each processing module to a number indicating the order of the record in the tabular data for each processing module, and
means for allocating a global item value number uniquely defined among the plurality of processing modules to the item value in the value list for each processing module by sending the value list from each processing module to other processing modules logically connected in the loop, receiving the value lists from the other processing modules to each processing module, calculating a count of the item values which are included in the value lists received from the other processing modules and rank previous to the item value in the value list for each processing module, and raising the item value numbers in the value list for each processing module by the count.

41. An information processing system having a plurality of processing modules logically connected to one another in a loop, in which
each processing module includes a memory to store a local information block representing tabular data,
the local information block includes a pointer array which contains information specifying item value numbers in order of records in the tabular data and a value list which contains item values in the tabular data in order of the item value numbers corresponding to the item values,
the records in the tabular data for each processing module are assigned respective global sequence numbers uniquely defined among the plurality of processing modules, and
global item value numbers uniquely defined among the plurality of processing modules are allocated to the respective item values in the value list for each processing module, wherein each processing module comprises:
means for identifying records to be deleted; and
means for lowering the global sequence numbers which rank subsequent to the global sequence numbers assigned to the records to be deleted by a count of the records to be deleted and deleting the information specifying the item value numbers corresponding to the records to be deleted from the pointer array.

42. An information processing system having a plurality of processing modules logically connected to one another in a loop, in which
each processing module includes a memory to store a local information block representing tabular data,
the local information block includes a pointer array which contains information specifying item value numbers in order of records in the tabular data and a value list which contains item values in the tabular data in order of the item value numbers corresponding to the item values,
the records in the tabular data for each processing module are assigned respective global sequence numbers uniquely defined among the plurality of processing modules, and
global item value numbers uniquely defined among the plurality of processing modules are allocated to the respective item values in the value list for each processing module, wherein each processing module comprises:
means for identifying insertion locations of records to be inserted; and
means for raising the global sequence numbers which rank subsequent to the global sequence numbers assigned to the records to be inserted by a count of the records to be inserted and reserving areas at respective locations in the pointer array, the areas being where the information specifying the item value numbers corresponding to the records to be inserted is stored.

43. An information processing system having a plurality of processing modules logically connected to one another in a loop, in which
each processing module includes a memory to store a local information block representing tabular data,
the local information block includes a pointer array which contains information specifying item value numbers in order of records in the tabular data, and a value list which contains item values in the tabular data in order of the item value numbers corresponding to the item values,
the records in the tabular data of each processing module are assigned respective global sequence numbers uniquely defined among the plurality of processing modules, and
global item value numbers uniquely defined among the plurality of processing modules are allocated to the respective item values in the value list for each processing module, wherein each processing module comprises:
means for identifying records to be overwritten and setting overwrite data with which the records are to be overwritten;
means for creating pairs of item value numbers and item values representing the overwrite data;
means for updating the pointer array and the value list in the local information block including the records to be overwritten by merging the created pairs of the item value numbers and the item values; and
means for allocating new global item value numbers among the plurality of the processing modules to the respective item values in the value list for each processing module by sending the value list from each processing module to other processing modules logically connected in the loop, receiving the value lists from the other processing modules to each processing module, and comparing the value list for each processing module with the value lists from the other processing modules.

44. An information processing system having a plurality of processing modules logically connected to one another in a loop, in which
each processing module includes a memory to store a local information block representing tabular data,
the local information block includes a pointer array which contains information specifying item value numbers in order of records in the tabular data, and a value list which contains item values in the tabular data in order of the item value numbers corresponding to the item values,
the records in the tabular data for each processing module are assigned respective global sequence numbers uniquely defined among the plurality of processing modules, and
global item value numbers uniquely defined among the plurality of processing modules are allocated to the respective item values in the value list for each processing module, wherein each processing module comprises:
means for updating the value list so that the item value corresponding to a current item value number specified by an element of a current pointer array, the item value being one of the item values stored in the value list of the local information block, is stored in order of the current item value number; and
means for updating the information specifying the current item value number stored in the current pointer array so as to specify the item value stored in the updated value list.

45. An information processing system having a plurality of processing modules logically connected to one another in a loop, in which
each processing modules includes a memory to store a local information block representing tabular data,
the local information block includes a pointer array which contains information specifying item value numbers in order of records in the tabular data, and a value list which contains item values in the tabular data in order of the item value numbers corresponding to the item values,
the records in the tabular data for each processing module are assigned global sequence numbers uniquely defined among the plurality of processing modules, and
global item value numbers uniquely defined among the plurality of processing modules are allocated to the respective item values in the value list for each processing module, wherein each processing module comprises:
means for determining a number of new records to be rearranged in each processing module;
means for assigning new global sequence numbers to the respective new records to be rearranged based on the number of the new records;
means for sending a current global sequence number assigned to a current record in each processing module and the item value, that is corresponding to the current global sequence number, in a current value list from each processing module to other processing modules logically connected in the loop,
means for receiving the current global sequence number in the other processing modules and the corresponding item value in the current value list from the other processing modules to each processing module,
means for storing the item value corresponding to the current global sequence number equal to the new current sequence number assigned to the new record to be rearranged in each processing module as a temporary value list into the memory, said current global sequence number being one of the current global sequence numbers received from the other processing modules,
means for creating a new pointer array and a new value list in each processing module, the new pointer array containing information specifying new item value numbers in order of the new records and the new value list containing the item values from the temporary value list in order of the new item value numbers,
means for sending the new value list from each processing module to the other processing modules logically connected in the loop,
means for receiving the new value lists of the other processing modules from the other processing modules to each processing module, and
means for comparing the new value list in each processing modules with the new value lists from the other processing modules and allocating a new global item value number uniquely defined among the plurality of processing modules to the item value in the new value list for each processing modules.
